(19) United States
(12) Patent Application Publication
(10) Pub. No.: US 2017/0061435 A1
(43) Pub. Date: Mar. 2, 2017

(54) Using a secondary identifier to select a data set

(71) Applicants: David Armes, Phoenix, AZ (US); Fred Bishop, Glendale, AZ (US); Peter D Saunders, Salt Lake City, UT (US)

(72) Inventors: David Armes, Phoenix, AZ (US); Fred Bishop, Glendale, AZ (US); Peter D Saunders, Salt Lake City, UT (US)

(73) Assignee: AMERICAN EXPRESS TRAVEL RELATED SERVICES COMPANY, INC., New York, NY (US)

(21) Appl. No.: 11/160,627

(22) Filed: Jun. 30, 2005

Related U.S. Application Data
(63) Continuation-in-part of application No. 10/711,720, filed on Sep. 30, 2004, now Pat. No. 7,996,324.
Application No. 10/711,720 is a continuation-in-part of application No. 10/708,545, filed on Mar. 10, 2004, now Pat. No. 7,668,750.
Application No. 10/708,545 is a continuation-in-part of application No. 10/340,352, filed on Jan. 10, 2003, now Pat. No. 7,889,052.
Application No. 10/340,352 is a continuation-in-part of application No. 10/192,488, filed on Jul. 9, 2002, now Pat. No. 7,239,226.
(60) Provisional application No. 60/507,803, filed on Sep. 30, 2003.
(60) Provisional application No. 60/396,577, filed on Jul. 16, 2002.
(60) Provisional application No. 60/304,216, filed on Jul. 10, 2001.

(51) Int. Cl. G06Q 20/40; G06Q 20/38; G06K 7/00

(52) U.S. Cl. CPC G06Q 20/4012; G06K 7/0004; G06Q 20/3821; G06Q 20/40145; G06Q 2220/00

(57) ABSTRACT

Systems and methods are configured to manage data sets associated with multiple transaction devices. The first and second data sets are associated with first and second owners, respectively, and are configured to be stored independent of each other The transaction devices user may be permitted to select at least one of the multiple data sets for transaction completion using a secondary identifier indicia. Where the user selects multiple accounts for transaction completion, the user may be permitted to allocate portions of a transaction to the selected transaction accounts from multiple transaction devices.

### CROSS-REFERENCE TO RELATED APPLICATIONS

This invention is a continuation-in-part of and claims priority to U.S. patent application Ser. No. 10/711,720, titled “SYSTEMS AND METHODS FOR MANAGING MULTIPLE ACCOUNTS ON A RF TRANSACTION DEVICE USING SECONDARY IDENTIFICATION INDICIA,” filed Sep. 30, 2004. This invention is also a continuation-in-part of and claims priority to U.S. patent application Ser. No. 10/708,545, titled “SYSTEM AND METHOD FOR SECURING RF TRANSACTIONS USING A RADIO FREQUENCY IDENTIFICATION DEVICE INCLUDING A COUNTER,” filed Mar. 10, 2004. Both the '720 and '545 applications claim priority to U.S. Provisional Application No. 60/507,803, filed Sep. 30, 2003. This invention is also a continuation-in-part of and claims priority to U.S. patent application Ser. No. 10/340,352, entitled “SYSTEM AND METHOD FOR INCENTING PAYMENT USING RADIO FREQUENCY IDENTIFICATION IN CONTACT AND CONTACTLESS TRANSACTIONS,” filed Jan. 10, 2003 (which itself claims priority to U.S. Provisional Patent Application No. 60/396,577, filed Jul. 16, 2002), and is also a continuation-in-part and claims priority to U.S. patent application Ser. No. 10/192,488, entitled “SYSTEM AND METHOD FOR PAYMENT USING RADIO FREQUENCY IDENTIFICATION IN CONTACT AND CONTACTLESS TRANSACTIONS,” filed on Jul. 9, 2002 (which itself claims priority to U.S. Provisional Patent Application No. 60/304,216, filed Jul. 10, 2001. All of the above-listed applications are incorporated herein by reference.

### FIELD OF INVENTION

This invention generally relates to a system and method for using a PIN to select an account on an RFID device. More specifically, the invention relates to using different PINs to select different accounts stored on different RFID devices.

### BACKGROUND OF INVENTION

Some transaction devices, such as credit cards and loyalty program cards, are capable of accessing information related to multiple accounts. For example, a credit card may be able to access membership data associated with both a credit card account and a wholesale purchase club account. These transaction devices may generally include one or more applications for selecting and then securely utilizing a sub-set of specified account information. However, the systems associated with these cards typically delegate the loading of these applications and management of the related data sets to third parties on behalf of both the issuer of the instrument and “application tenants” residing on the issuer's transaction devices. Managing data associated with a credit card via the issuer/third party may involve time consuming steps such as requesting permission to manage data, conforming to data standard formats, and implementing changes. Thus, traditional solutions for managing multiple application tenants are disadvantageous in that the traditional solutions leave a disproportional burden on the issuer and/or the delegated third party in terms of managing accounts on a transaction device.

Another disadvantage is that, in general, the transaction devices, which are capable of accessing information related to multiple accounts, are typically designed to access only those multiple accounts managed by the same issuer. For example, the same issuer provides both the credit card and the wholesale purchase club account to the user. As such, the issuer providing both accounts generally establishes its own application tenant storage format and management protocol related to the accounts. The established format and protocol is ordinarily different from any format or protocol used by other unrelated issuers, which provides the issuer increased control over access to the account data. Because of the differing unique protocols/formats amongst issuers, multiple issuers typically provide a transaction device corresponding to an account offered by the issuer, where the data for accessing the account is stored in that issuer's protocol/format.

Conventional multiple account management systems are further disadvantaged in that the systems are not configured to permit the system user to select which one of the multiple accounts to use to complete a transaction. Ordinarily, conventional multiple account systems are configured such that a particular account for completing a transaction is selected by the system without any input from the system user. The system user generally has little or no input into the account selected. Thus, conventional systems limit a user's ability to manage the user's transaction accounts according to the user's needs. With the influx of RFID technologies and devices, a problem exists in which multiple devices may be detected and/or communicated by an RFID reader. As such, there is a need for an easy way to distinguish and choose an account from a list of multiple accounts.

### SUMMARY OF INVENTION

The invention includes a method for facilitating access to at least one data set that is stored on one of a plurality of RF transaction devices. The method comprises the steps of using a first PIN to select an account that corresponds to a first RF transaction device and using a second PIN to select an account that corresponds to a second RF transaction device.

These features and other advantages of the system and method, as well as the structure and operation of various exemplary embodiments of the system and method, are described below.

### BRIEF DESCRIPTION OF THE DRAWINGS

The accompanying drawings, wherein like numerals depict like elements, illustrate exemplary embodiments of the invention, and together with the description, serve to explain the principles of the invention. In the drawings:

FIG. 1 illustrates a block diagram of an exemplary transaction device in accordance with the invention;

FIG. 2 illustrates an exemplary block diagram of an RFID reader in accordance with the invention;

FIG. 3 illustrates an exemplary method of data set management according to the invention;

FIG. 4 illustrates a flowchart of an exemplary authentication process in accordance with the invention;

FIG. 5 illustrates an exemplary data set management system in accordance with the invention;

FIG. 6 illustrates an exemplary general overview of an exemplary data set management method in accordance with the invention;

FIG. 7 depicts an exemplary method for user and issuer system data management in accordance with the invention;

FIG. 8 depicts an exemplary method for user and issuer system data management in accordance with the invention;

FIG. 9 illustrates an exemplary method by which a user may choose which of the data sets to use to complete a transaction in accordance with the invention;

FIG. 10 depicts an exemplary screen shot of a display screen that may be presented to user for transaction account selection;

FIG. 11 depicts an exemplary screen shot that RFID reader may provide to a user subsequent to the selection of a particular transaction account number in accordance with the invention;

FIG. 12 depicts an exemplary screen shot that RFID reader may provide to a user to provide what percentage of the transaction request is to be allocated to a first transaction account number;

FIG. 13 depicts an exemplary screen shot that includes relevant information pertaining to an allocation made to the first transaction account number;

FIG. 14 illustrates an exemplary method for selecting from amongst the multiple transaction account numbers contained on multiple transaction devices in accordance with the invention; and

FIG. 15 depicts an exemplary screen shot of a display screen that may be presented to a user for transaction account selection using a plurality of transaction devices in accordance with the invention.

### DETAILED DESCRIPTION

The invention may be described herein in terms of functional block components, optional selections and/or various processing steps. It should be appreciated that such functional blocks may be realized by any number of hardware and/or software components configured to perform the specified functions. For example, the invention may employ various integrated circuit components (e.g., memory elements, processing elements, logic elements, look-up tables, and/or the like), which may carry out a variety of functions under the control of one or more microprocessors or other control devices. Similarly, the software elements of the invention may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the invention may employ any number of conventional techniques for data transmission, signaling, data processing, network control, and/or the like. For a basic introduction of cryptography and network security, the following may be helpful references: (1) “Applied Cryptography: Protocols, Algorithms, And Source Code In C,” by Bruce Schneier, published by John Wiley & Sons (second edition 1996); (2) “Java Cryptography” by Jonathan Knudson, published by O'Reilly & Associates (1998); and (3) “Cryptography and Network Security: Principles and Practice” by Mayiam Stalling, published by Prentice Hall; all of which are hereby incorporated by reference.

As used herein, the terms “user,” “end user,” consumer,” “customer” or “participant” may be used interchangeably with each other, and each shall mean any person, entity, machine, hardware, software and/or business. Furthermore, the terms “business” or “merchant” may be used interchangeably with each other and shall mean any person, entity, machine, hardware, software or business. Further still, the merchant may be any person, entity, software and/or hardware that is a provider, broker and/or any other entity in the distribution chain of goods or services. For example, the merchant may be a ticket/event agency (e.g., Ticketmaster, Telecharge, Clear Channel, brokers, agents).

The systems and/or components of the systems discussed herein may also include one or more host servers or other computing systems including a processor configured to process digital data, a memory coupled to the processor for storing digital data, an input digitizer coupled to the processor for inputting digital data, an application program stored in the memory and accessible by the processor for directing processing of digital data by the processor, a display coupled to the processor and memory for displaying information derived from digital data processed by the processor and a plurality of databases, the databases including client data, merchant data, financial institution data and/or like data that may be used in association with the invention. As those skilled in the art may appreciate, the user interface for each system described herein may typically include an operating system (e.g., Windows NT, 95/98/2000, Linux, Solaris, etc.) as well as various conventional support software and drivers typically associated with computers. The user computer and other systems described herein can be in a home or business environment with access to a network. In an exemplary embodiment, access is through the Internet through a commercially-available web-browser software package.

Communication between various elements of the invention is accomplished through any suitable communication means, such as, for example, a telephone network, intranet, Internet, point-of-sale device (point-of-sale device, personal digital assistant, cellular phone, kiosk, etc.), online communications, off-line communications, wireless communications, and/or the like. One skilled in the art may also appreciate that, for security reasons, any databases, systems, or components of the invention may consist of any combination of databases or components at a single location or at multiple locations, wherein each database or system includes any of various suitable security features, such as firewalls, access codes, encryption, decryption, compression, decompression, and/or the like.

The systems may be suitably coupled to the network via data links. A variety of conventional communications media and protocols may be used for data links. For example, a connection to an Internet Service Provider (ISP) over the local loop as is typically used in connection with standard modem communication, cable modem, Dish networks, ISDN, Digital Subscriber Line (DSL), or various wireless communication methods. The merchant system might also reside within a local area network (LAN) that interfaces to the network via a leased line (T1, D3, etc.). Such communication methods are well known in the art and are covered in a variety of standard texts. See, e.g., Gilbert Held, “Understanding Data Communications” (1996), hereby incorporated by reference.

The computing units may be connected with each other via a data communication network. The network may be a public network and assumed to be insecure and open to eavesdroppers. In the illustrated implementation, the network may be embodied as the Internet. In this context, the computers may or may not be connected to the Internet at all times. For instance, the customer computer may employ a modem to occasionally connect to the Internet, whereas the bank computing center might maintain a permanent connection to the Internet. Specific information related to the protocols, standards, and application software utilized in connection with the Internet may not be discussed herein. For further information regarding such details, see, for example, Dilip Naik, “Internet Standards and Protocols” (1998); “Java 2 Complete,” various authors (Sybex 1999); Deborah Ray and Eric Ray, “Mastering HTML 4.0” (1997); Loshin, “TCP/IP Clearly Explained” (1997). All of these texts are hereby incorporated by reference.

It may be appreciated that many applications of the invention may be formulated. One skilled in the art may appreciate that a network may include any system for exchanging data or transacting business, such as the Internet, an intranet, an extranet, WAN, LAN, satellite communications, and/or the like. It is noted that the network may be implemented as other types of networks, such as an interactive television (ITV) network. The users may interact with the system via any input device such as a keyboard, mouse, kiosk, personal digital assistant, handheld computer (e.g., Palm Pilot®), cellular phone and/or the like. Similarly, the invention may be used in conjunction with any type of personal computer, network computer, workstation, minicomputer, mainframe, or the like running any operating system such as any version of Windows, Windows NT, Windows2000, Windows 98, Windows 95, MacOS, OS/2, BeOS, Linux, UNIX, Solaris or the like. Moreover, although the invention is frequently described herein as being implemented with TCP/IP communications protocols, it may be readily understood that the invention may also be implemented using IPX, Appletalk, IP-6, NetBIOS, OSI or any number of existing or future protocols. Moreover, the invention contemplates the use, sale or distribution of any goods, services or information over any network having similar functionality described herein.

In accordance with various embodiments of the invention, the Internet Information Server, Microsoft Transaction Server, and Microsoft SQL Server, are used in conjunction with the Microsoft operating system, Microsoft NT web server software, a Microsoft SQL database system, and a Microsoft Commerce Server. Additionally, components such as Access or SQL Server, Oracle, Sybase, Informix MySQL, Interbase, etc., may be used to provide an ADO-compliant database management system. The term “webpage” as it is used herein is not meant to limit the type of documents and applications that might be used to interact with the user. For example, a typical website might include, in addition to standard HTML documents, various forms, Java applets, Javascript, active server pages (ASP), common gateway interface scripts (CGI), extensible markup language (XML), dynamic HTML, cascading style sheets (CSS), helper applications, plug-ins, and/or the like.

The transaction device may communicate to the merchant, information from one or more data sets associated with the transaction device. In one example, membership data and credit card data associated with an account or card may be transmitted using any conventional protocol for transmission and/or retrieval of information from an account or associated transaction card (e.g., credit, debit, loyalty, etc.). In one exemplary embodiment, the transaction device may be configured to communicate via RF signals. As such, the data contained on the instrument may be communicated via radio frequency signals.

A transaction device as used herein, may include one or more physical devices configured for RFID communication used in carrying out various transactions. The RF transaction device may include information relating to any type of transaction account, including, for example, account information from a rewards card, charge card, credit card, debit card, prepaid card, telephone card, smart card, magnetic stripe card, radio frequency card/transponder and/or the like. In yet another exemplary embodiment of the invention, a transaction device may include account information such as an electronic coupon, voucher, and/or other such information. Typical form factors may include a watch, card, transaction device, or the like. Furthermore, the transaction device may be physically configured to have any decorative or fanciful shape including key chains, jewelry and/or the like. For ease in understanding, the RF transaction device may be referred to, herein, as a “transaction device.”

The transaction device in accordance with this invention may be used to pay for acquisitions, obtain access, provide identification, pay an amount, receive payment, redeem reward points and/or the like. In the radio frequency (“RF”) embodiments of the transaction device, instrument to instrument transactions may also be performed. See, for example, Sony's “Near Field Communication” (“NFC”) emerging standard which is touted as operating on 13.56 MHz and allowing the transfer of any kind of data between NFC enabled devices and across a distance of up to twenty centimeters. See also, Bluetooth chaotic network configurations; described in more detail at http://www.palowireless.com/infotooth/whatis.asp, which is incorporated herein by reference. Furthermore, data on a first RF device may be transmitted directly or indirectly to another RF device to create a copy of all or part of the original device. For more information on radio frequency enabled transaction devices, see U.S. patent application Ser. No. 10/340,352, entitled “SYSTEM AND METHOD FOR INCENTING PAYMENT USING RADIO FREQUENCY IDENTIFICATION IN CONTACT AND CONTACTLESS TRANSACTIONS,” filed Jan. 10, 2003, incorporated herein by reference.

Furthermore, a transaction device as described herein may be associated with various applications which allow the transaction devices to participate in various programs, such as, for example, loyalty programs. A loyalty program may include one or more loyalty accounts. Exemplary loyalty programs include frequent flyer miles, on-line points earned from viewing or purchasing products or websites on-line and programs associated with diner's cards, credit cards, debit cards, hotel cards, calling cards, and/or the like. Generally, the user is both the owner of the transaction account and the participant in the loyalty program; however, this association is not necessary. For example, a participant in a loyalty program may gift loyalty points to a user who pays for a purchase with his own transaction account, but uses the gifted loyalty points instead of paying the monetary value. The transaction device may furthermore be associated with coupon information or the like.

For more information on loyalty systems, transaction systems, and electronic commerce systems, see, for example, U.S. Utility patent application Ser. No. 10/304,251, filed Nov. 26, 2002, by inventors Antonucci, et al., and entitled “System and Method for Transfer of Loyalty Points”; U.S. patent application Ser. No. 10/378,456, filed Mar. 3, 2003, by inventors Antonucci, et al., and entitled “System and Method for the Real-Time Transfer of Loyalty Points Between Accounts”; U.S. patent application Ser. No. 09/836,213, filed Apr. 17, 2001, by inventors Voltmer, et al., and entitled “System And Method For Networked Loyalty Program”; U.S. patent application Ser. No. 10/027,984, filed Dec. 20, 2001, by inventors Ariff, et al., and entitled “System And Method For Networked Loyalty Program”; U.S. patent application Ser. No. 10/010,947, filed Nov. 6, 2001, by inventors Haines, et al., and entitled “System And Method For Networked Loyalty Program”; U.S. patent application Ser. No. 10/084,744, filed Feb. 26, 2002, by inventors Bishop, et al., and entitled “System And Method For Securing Data Through A PDA Portal”; the Shop AMEX™ system as disclosed in U.S. Ser. No. 60/230,190, filed Sep. 5, 2000; the Loyalty As Currency™ and Loyalty Rewards Systems disclosed in U.S. Ser. No. 60/197,296, filed Apr. 14, 2000, U.S. Ser. No. 60/200,492, filed Apr. 28, 2000, U.S. Ser. No. 60/201,114, filed May 2, 2000; a digital wallet system disclosed in U.S. Ser. No. 09/652,899, filed Aug. 31, 2000; a stored value card as disclosed in U.S. Ser. No. 09/241,188, filed Feb. 1, 1999; a system for facilitating transactions using secondary transaction numbers disclosed in U.S. Ser. No. 09/800,461, filed Mar. 7, 2001, and also in related U.S. provisional applications Ser. No. 60/187,620, filed Mar. 7, 2000, Ser. No. 60/200,625, filed Apr. 28, 2000, and Ser. No. 60/213,323, filed May 22, 2000, all of which are herein incorporated by reference. Other examples of online loyalty systems are disclosed in Netcentives U.S. Pat. No. 5,774,870, issued Jun. 30, 1998, and U.S. Pat. No. 6,009,412, issued Dec. 29, 1999, both of which are hereby incorporated by reference.

Further still, a “code,” “account,” “account number,” “identifier,” “secondary identifier,” “loyalty number” or “membership identifier,” as used herein, includes any device, code, or other identifier/indicia suitably configured to allow the consumer to interact or communicate with the system, such as, for example, authorization/access code, personal identification number (PIN), Internet code, biometric identifier, other identification code, and/or the like that is optionally located on a rewards card, charge card, credit card, debit card, prepaid card, telephone card, smart card, magnetic stripe card, bar code card, radio frequency card and/or the like. The account number may be distributed and stored in any form of plastic, electronic, magnetic, radio frequency, audio and/or optical device capable of transmitting or downloading data from itself to a second device. A customer account number may be, for example, a sixteen-digit credit card number, although each credit provider has its own numbering system, such as the fifteen-digit numbering system used by an exemplary loyalty system. Each company's credit card numbers comply with that company's standardized format such that the company using a sixteen-digit format may generally use four spaced sets of numbers, as represented by the number “0000 0000 0000 0000”. The first five to seven digits are reserved for processing purposes and identify the issuing bank, card type and etc. In this example, the last sixteenth digit is used as a sum check for the sixteen-digit number. The intermediary eight-to-ten digits are used to uniquely identify the customer. In addition, loyalty account numbers of various types may be used.

Further yet, the “transaction information” in accordance with this invention may include the nature or amount of transaction, as well as, a merchant, user, and/or issuer identifier, security codes, or routing numbers, and the like. In various exemplary embodiments of the invention, one or more transaction accounts may be used to satisfy or complete a transaction. For example, the transaction may be only partially completed using the transaction account(s) correlating to the application tenant information stored on the transaction device with the balance of the transaction being completed using other sources. Cash may be used to complete part of a transaction and the transaction account associated with a user and the transaction device, may be used to satisfy the balance of the transaction. Alternatively, the user may identify which transaction account, or combination of transaction accounts, stored on the transaction device the user desires to complete the transaction. Any known or new methods and/or systems configured to manipulate the transaction account in accordance with the invention may be used.

In various exemplary embodiments, the transaction device may be embodied in form factors other than, for example, a card-like structure. As already mentioned, the transaction device may comprise an RF transponder, a speed pass, or other similar device. The transaction device may be configured to communicate via a radio frequency transponder to the merchant systems or account systems. In yet another embodiment, the transaction device may be configured to comprise two or more antennae that are both configured to send and receive information and the transaction device may be responsive to different RF frequencies. In one exemplary embodiment, each antenna may be configured to communicate using a particular protocol and/or frequency. Thus, the transaction device may be configured to communicate with two or more reader devices that each communicate with the transaction device using different transmission frequencies.

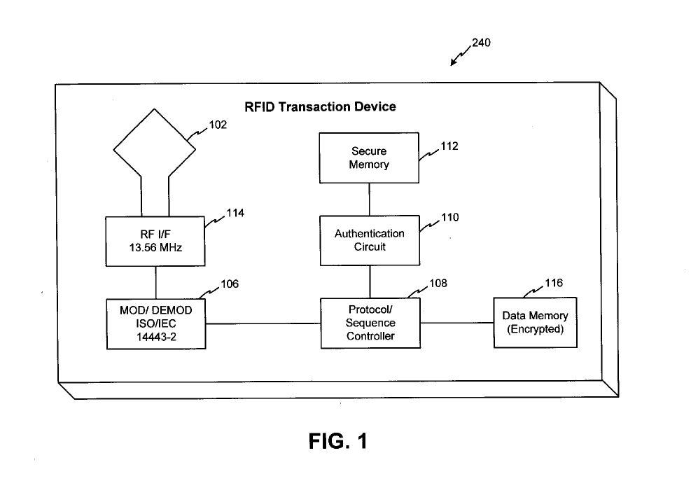

FIG. 1 illustrates a block diagram of an exemplary transaction device 240 in accordance with the invention. As described above, transaction device 240 may be a RFID transaction device 240 which may be presented by the user to facilitate an exchange of funds or points, etc., for receipt of goods or services. Transaction device 240 discussed herein may also be a “pervasive computing device,” which may include a traditionally non-computerized device that is embedded with a computing unit. Examples can include watches, Internet enabled kitchen appliances, restaurant tables embedded with RF readers, wallets or purses with imbedded transponders, etc.

Transaction device 240 may include an antenna 102 for receiving an interrogation signal from RFID reader 280 via antenna 202 (or alternatively, via external antenna 226). Transaction device antenna 102 may be in communication with a transponder 114. In one exemplary embodiment, transponder 114 may be a 13.56 MHz transponder compliant with the ISO/IEC 14443 standard, and antenna 102 may be of the 13 MHz variety. The transponder 114 may be in communication with a transponder compatible modulator/demodulator 106 configured to receive the signal from transponder 114 and configured to modulate the signal into a format readable by any later connected circuitry. Further, modulator/demodulator 106 may be configured to format (e.g., demodulate) a signal received from the later connected circuitry in a format compatible with transponder 114 for transmitting to RFID reader 280 via antenna 102. For example, where transponder 114 is of the 13.56 MHz variety, modulator/demodulator 106 may be ISO/IEC 14443-2 compliant.

Modulator/demodulator 106 may be coupled to a protocol/sequence controller 108 for facilitating control of the authentication of the signal provided by RFID reader 280, and for facilitating control of the sending of transaction device 240 account number. In this regard, protocol/sequence controller 108 may be any suitable digital or logic driven circuitry capable of facilitating determination of the sequence of operation for transaction device 240 inner-circuitry. For example, protocol/sequence controller 108 may be configured to determine whether the signal provided by the RFID reader 280 is authenticated, and thereby providing to the RFID reader 280 the account number stored on transaction device 240.

Protocol/sequence controller 108 may be further in communication with authentication circuitry 110 for facilitating authentication of the signal provided by RFID reader 280. Authentication circuitry 110 may be further in communication with a non-volatile secure memory database 112. Secure memory database 112 may be any suitable elementary file system such as that defined by ISO/IEC 7816-4 or any other elementary file system allowing a lookup of data to be interpreted by the application on the fob.

Databases may be organized in any suitable manner, including as data tables or lookup tables. Association of certain data may be accomplished through any data association technique known and practiced in the art. For example, the association may be accomplished either manually or automatically. Association techniques include common techniques such as using a key field in the tables to speed searches, sequential searches through all the tables and files, and sorting records in the file according to a known order to simplify lookup.

The data corresponding to the key field may be used by protocol/sequence controller 108 for data analysis and used for management and control purposes, as well as security purposes. Authentication circuitry may authenticate the signal provided by RFID reader 280 by association of the RFID signal to authentication keys stored on database 112. Encryption circuitry may use keys stored on database 112 to perform encryption and/or decryption of signals sent to or from the RFID reader 280.

In addition, protocol/sequence controller 108 may be in communication with a database 116 for storing at least one or more transaction devices 240 account data, and a unique transaction devices 240 identification code. Protocol/sequence controller 108 may be configured to retrieve the account number from database 116 as desired. Database 116 may be of the same configuration as database 112 described above. The transaction device account data and/or unique transaction device identification code stored on database 116 may be encrypted prior to storage. Thus, where protocol/sequence controller 108 retrieves the account data, and or unique transaction device identification code from database 116, the account number may be encrypted when being provided to RFID reader 280. Further, the data stored on database 116 may include, for example, an unencrypted unique transaction devices 240 identification code, a user identification, Track 1 and 2 data, as well as specific application applets.

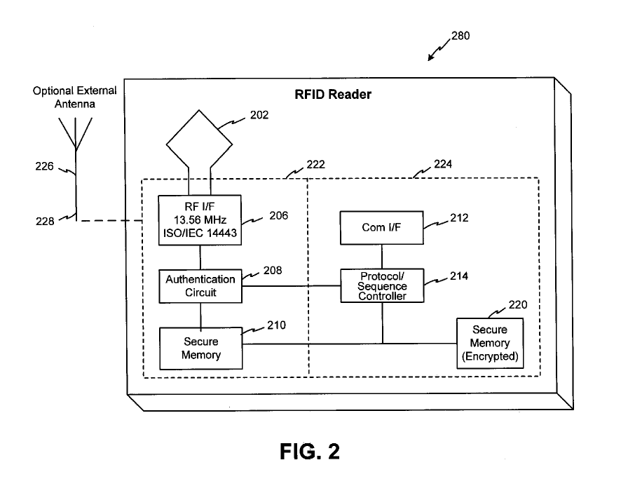

FIG. 2 illustrates an exemplary block diagram of an RFID reader 280 in accordance with the invention. RFID reader 280 includes, for example, an antenna 202 coupled to a RF module 222, which is further coupled to a control module 224. In addition, RFID reader 280 may include an antenna 226 positioned remotely from the RFID reader 280 and coupled to RFID reader 280 via a suitable cable 228, or other wire or wireless connection.

RF module 222 and antenna 202 may be suitably configured to facilitate communication with transaction devices 240. Where transaction devices 240 are formatted to receive a signal at a particular RF frequency, RF module 222 may be configured to provide an interrogation signal at that same frequency. For example, in one exemplary embodiment, transaction devices 240 may be configured to respond to an interrogation signal of about 13.56 MHz. In this case, RFID antenna 202 may be 13 MHz and may be configured to transmit an interrogation signal of about 13.56 MHz.

Further, protocol/sequence controller 214 may include an optional feedback function for notifying the user of the status of a particular transaction. For example, the optional feedback may be in the form of an LED, LED screen and/or other visual display which is configured to light up or display a static, scrolling, flashing and/or other message and/or signal to inform transaction devices 240 user or any other third party that the transaction is initiated (e.g., transaction device is being interrogated), the transaction device is valid (e.g., transaction device is authenticated), transaction is being processed, (e.g., transaction device account number is being read by RFID reader) and/or the transaction is accepted or denied (e.g., transaction approved or disapproved). Such an optional feedback may or may not be accompanied by an audible indicator (or may present the audible indicator singly) for informing transaction devices 240 user of the transaction status. The audible feedback may be a simple tone, multiple tones, musical indicator, and/or voice indicator configured to signify when transaction devices 240 are being interrogated, the transaction status, or the like.

RFID antenna 202 may be in communication with a transponder 206 for transmitting an interrogation signal and receiving at least one of an authentication request signal and/or an account data from transaction devices 240. Transponder 206 may be of similar description as transponder 114 of FIG. 1. In particular, transponder 206 may be configured to send and/or receive RF signals in a format compatible with antenna 102 in a similar manner as was described with respect to transaction device transponder 114. For example, where transponder 206 is 13.56 MHz RF rated antenna 102 may be 13.56 MHz compatible. Similarly, where transponder 206 is ISO/IEC 14443 rated, antenna 202 may be ISO/IEC 14443 compatible.

RF module 222 may include, for example, transponder 206 in communication with authentication circuitry 208 which may be in communication with a secure database 210 and/or secure memory 220. Authentication circuitry 208 and database 210 may be of similar description and operation as described with respect to authentication circuitry 110 and secure memory database 112 of FIG. 1. For example, database 210 may store data corresponding to transaction devices 240 which are authorized to transact business over system 200. Database 210 may additionally store RFID reader 280 identifying information for providing to transaction devices 240 for use in authenticating whether RFID reader 280 is authorized to be provided the transaction device account number stored on transaction device database 116.

Authentication circuitry 208 may be of similar description and operation as authentication circuitry 110. That is, authentication circuitry 208 may be configured to authenticate the signal provided by transaction devices 240 in a similar manner that authentication circuitry 110 may be configured to authenticate the signal provided by RFID reader 280. In one exemplary embodiment, transaction devices 240 and RFID reader 280 engage in mutual authentication. In this context, “mutual authentication” may mean that operation of the system 200 may not take place until transaction devices 240 authenticates the signal from RFID reader 280, and RFID reader 280 authenticates the signal from transaction devices 240. For a detailed explanation of a suitable transaction processing method and mutual authentication process for use with the invention, see, for example, U.S. patent application Ser. No. 10/192,488, titled “SYSTEM AND METHOD FOR PAYMENT USING RADIO FREQUENCY IDENTIFICATION IN CONTACT AND CONTACTLESS TRANSACTIONS,” filed Jul. 9, 2002, and U.S. patent application Ser. No. 10/340,352, titled “System and Method for Incenting Payment Using Radio Frequency Identification In Contact and Contactless Transactions,” filed Jan. 10, 2003, both incorporated herein by reference.

Transaction devices 240 may provide the reader 280 with transaction device data for use in authenticating a transaction request at issuer system 230. For example, transaction devices 240 may include a counter or random number generator (not shown) which may be provided to the issuer system for use in transaction devices 240, reader 280, or transaction verification. The issuer system 240 may receive the counter or random number for use in determining whether to authorize the transaction. Suitable methods for using a counter or random number generator are disclosed in, for example, U.S. patent application Ser. No. 10/708,547, titled “SYSTEM AND METHOD FOR SECURING RF TRANSACTIONS USING A RADIO FREQUENCY IDENTIFICATION DEVICE INCLUDING A RANDOM NUMBER GENERATOR,” filed Mar. 10, 2004, and U.S. patent application Ser. No. 10/708,545, titled “SYSTEM AND METHOD FOR SECURING RF TRANSACTIONS USING A RADIO FREQUENCY IDENTIFICATION DEVICE INCLUDING A TRANSACTIONS COUNTER,” filed Mar. 10, 2004, both incorporated herein by reference.

As used herein, the terms “account information” or “data set” may include any set of information and/or the like which may be used, for example, in completing a transaction. For example, data sets may include information related to credit card accounts, debit card accounts, membership club accounts, loyalty program accounts, speed pass accounts, rental car memberships, frequent flyer programs, coupons, tickets and/or the like. This information may include membership identifiers, account number(s), personal information, balances, past transaction details, account issuer routing number, cookies, identifiers, security codes, and/or any other information. The data set may additionally include an issuer defined management process for determining which subsets of data are to be provided to an issuer or merchant. In some instances, a data set may be associated with one or more account numbers corresponding to accounts maintained by the account issuer.

To facilitate understanding of the invention, the single and/or multiple data sets contained on one or more transaction devices are discussed with reference to distinct transaction account numbers associated with corresponding transaction accounts maintained by distinct issuer systems. Each one of the multiple transaction account numbers, or a plurality of the transaction account numbers, may be correlated to a single issuer system. However, for ease in understanding, the invention is discussed with reference to a first data set correlating to a first issuer system, and a second data set correlated to a second issuer system.

In one typical example, each transaction number is ordinarily stored on one or more transaction devices distinct from the other transaction numbers stored thereon. The transaction account numbers may include a routing number, transit number, bank identification number (BIN), or the like, which is used to identify issuer system that maintains the transaction account corresponding to the transaction account number. The transaction account number may additionally include a user account number, which is used by the issuer system to identify the transaction account to be used to complete the transaction. In one exemplary embodiment, the issuer system stores the user account number on the issuer system database correlative to the transaction account in such a manner that the issuer system may retrieve the transaction account for transaction completion by, for example, referencing the user account number.

The various data sets associated with a transaction device may either be stored on one or more transaction devices themselves or they may be stored remotely. In one exemplary embodiment, the transaction device itself is configured to store at least two data sets. In other exemplary embodiments, data sets may be stored in one or more databases and the data sets are affiliated with one or more transaction devices. For example, a central database on a first instrument may store multiple distinct data sets correlated with a first unique issuer. Further, a central database on a second instrument may store multiple distinct data sets correlated with a second unique issuer. The data sets stored on the remote database may be stored thereon, in such a manner as to mimic the corresponding first and second issuer data sets stored on the transaction device. The multiple distinct data sets may be accessed, for example, by a merchant system, whether stored on one of the transaction devices or the remote database stand alone device, and/or a computer user interface, via a network. In this example, one or more transaction devices may include one or more user identifiers (e.g., membership identifiers), which may be used to provide access to a subset of data included on any of the transaction devices.

Various information and data are described herein as being “stored.” In this context, “stored” may mean that the information is kept on a database. In accordance with the invention, a database may be any type of database, such as relational, hierarchical, object-oriented, and/or the like. Common database products that may be used to implement the databases include DB2 by IBM (White Plains, N.Y.), any of the database products available from Oracle Corporation (Redwood Shores, Calif.), Microsoft Access or MSSQL by Microsoft Corporation (Redmond, Wash.), or any other database product. A database may be organized in any suitable manner, including as data tables or lookup tables.

Although all data sets associated with a particular transaction device may be owned by the same owner, it is contemplated that in general, some of the data sets stored on the transaction device have different owners. Furthermore, the storage of data sets is configured to facilitate independent storage and management of the data sets on the transaction device. Further still, the data sets may be stored in distinct differing formats provided by the distinct issuer or data set owner (also called “issuer” herein). The owners of data sets may include different individuals, entities, businesses, corporations, software, hardware, and/or the like. However, one skilled in the art will appreciate that the owners may also include different divisions or affiliates of the same corporation or entity.

A data set may contain any type of information stored in digital format. For example, a data set may include account numbers, programs/applications, scripts, cookies, instruments for accessing other data sets, and/or any other information.

As discussed above, many issuers of existing transaction accounts utilize predetermined formats for account numbers, data and/or applications stored in association with the transaction device. Similarly, the data storage media associated with these transaction accounts are typically configured to accommodate specific predetermined data formats. Thus, since the data format associated with a first issuer is often different from a data format of a second issuer, storage of multiple distinct data of differing formats on one or more RFID devices provides complications for conventional systems. This is true since, each issuer typically maintains an account processing system that uses a processing protocol different from other issuers, and the information stored on the transaction device relative to the issuer must be formatted accordingly. As such, to ensure the security and integrity of the issuer-owned data, the loading of data on a transaction device is typically performed by an issuer or a third-party provider who typically uploads all related and similarly formatted data sets onto each transaction device desired to store the information. However, since the third party may typically only be authorized by the issuer to load issuer-owned data of similar format onto an issuer-provided transaction device, including differently formatted data sets on a single transaction device by the third party is often not permitted. More particularly, independent owners of data sets are often reluctant to conform their data set formats to a “standard format” because of the security advantages of maintaining a separate, distinct, often secreted format.

In contrast, and in accordance with an exemplary embodiment of the invention, the format of the information stored in the invention may vary from one data set to another. That is, the invention permits the data to be stored on the transaction device in any format, and more particularly, in any format recognizable by the data owner/transaction account issuer. Thus, as noted, each data set may be used for a very wide variety of purposes including storage of applications, raw data, cookies, coupons, membership data, account balances, loyalty information, and/or the like.

In accordance with one aspect of the invention, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); block of binary (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a Block of Binary (BLOB). Thus, any binary information can be stored in a storage space associated with a data set. As discussed above, the binary information may be stored on the transaction device or external to but affiliated with the transaction device. The BLOB method may store data sets as ungrouped data elements formatted as a block of binary via a fixed memory offset using either fixed storage allocation, circular queue techniques, or best practices with respect to memory management (e.g., paged memory, memory recently used, etc.). By using BLOB methods, the ability to store various data sets that have different formats facilitates the storage of data associated with one or more transaction devices by multiple and unrelated owners of the data sets. For example, a first data set which may be stored may be provided by a first issuer, a second data set which may be stored may be provided by an unrelated second issuer, and yet a third data set which may be stored, may be provided by a third issuer unrelated to the first and second issuers. Each of these three exemplary data sets may contain different information that is stored using different data storage formats and/or techniques. Further, each data set may contain subsets of data which also may be distinct from other subsets. Further still, each data set may be stored on one or more transaction devices (for example, each member of a household may have a transaction device with the same accounts, or an individual user may have multiple transaction devices, wherein each device is configured with two or more accounts).

Even further, the invention contemplates the use of a self-service user interaction device. In this context, the self-service user interaction device may be any device suitable for interacting with one or more transaction devices, and receiving information from the transaction device user and providing the information to a merchant, account issuer, account manager, data set owner, merchant point of sale, and the like. For example, the self-service user interaction device may be a stand alone read write device, self-service kiosk, merchant point of sale, read/write device, and the like. In one example, the self-service user interaction device may be configured to communicate information to and from a transaction device and to manipulate the data sets stored thereon. The self-service interaction device may be in communication with the various components of the invention using any communications protocol.

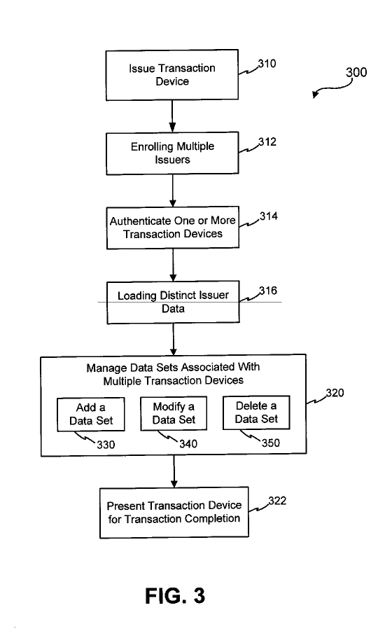

In general, systems and methods disclosed herein, are configured to facilitate the management of multiple distinct data sets associated with a transaction device. Management of data sets may include such steps as adding, augmenting, updating and/or deleting data sets associated with the transaction device. Such manipulations of the data may occur without replacing or reissuing the transaction device. With reference to FIG. 3, an exemplary method 300 according to the invention is shown. Method 300 may include issuing one or more transaction devices to a transaction device user (step 310), enrolling multiple data set owners in multiple accounts on one or more transaction devices (step 312), and managing data sets associated with multiple transaction devices (step 320). In managing the data, the method 300 may determine, for example, whether the data should be added to a data set (step 330), modified (step 340) or deleted (step 350), as described more fully below. Once the data is appropriately managed, the transaction device user may present the data contained on one or more instruments to a merchant system for completion of a transaction.

The system may be further configured such that, during an exemplary transaction, data sets associated with the transaction devices may be managed. For example, the user may be prompted (e.g., on a screen, by electronic voice, by a store clerk, by a signal and/or the like) as to the possibility of adding, for example, a loyalty account to one of the transaction devices and the user may also be presented with terms and/or conditions in a similar or different manner. The user may be prompted at any time during the transaction, but preferably the user is prompted at the completion of the transaction. If the user accepts the invitation to add data to one of more transaction devices, a new data set may be added (step 330) and/or an existing data set is updated (step 340). For example, if data is to be updated, the stand alone may locate appropriate data to be updated on one or more transaction devices, and make the updates (“modifications”) in accordance with data owner instructions. If the data is to be added, the stand alone device may be configured to provide any account information (e.g., account identifier, security code, data owner routing number, etc.) to one or more transaction devices for storage thereon. The stand alone may locate an appropriate database location on one or more transaction devices for storing the added data. The stand alone device facilitates storage of the data in a distinct location on the transaction device databases, where the data is stored independently of any other data. In a preferred embodiment of the invention, the data is added to a database location on a first transaction device which reserved for independently storing all data owned by a particular data set owner. Alternatively and/or in addition, the data may be stored in a distinct location on a second transaction device, which is a separate location than is used to store any other data set. Further still, the data set is stored in accordance with any storage protocol permitting the data to be stored and retrieved independently of other data.

The adding and updating of the data may be verified by the issuer, prior to making the modifications. If verified, all databases containing the data set to be updated or a mirror image of the data set to be updated, are modified in accordance with the user or issuer provided instructions, and/or the issuer defined data storage protocol or format.

In one exemplary embodiment, multiple account issuers may be enrolled in a multiple account management program using one or more transaction devices in accordance with the invention (step 312). For example, permission for adding account issuer-owned data may be obtained from the data set owner. The data set owner may then be requested to provide account information to be stored on one or more transaction devices. The data set owner may then provide account information relative to a distinct user account for loading onto one or more transaction devices in accordance with the invention. The issuers may be enrolled prior to issuance of the instrument or the issuers may be enrolled after issuance. By enrolling in the management program, the issuer may provide authorization for including the issuer-owned data on one or more transaction devices (step 314). The issuer-owned data may be included (e.g., added, deleted, modified, augmented, etc.) on a transaction device using a stand alone interaction device, merchant system, or user personal computer interface upon presentment of the transaction device to the stand alone interaction device 590 (step 316). The stand alone interaction device may manipulate the issuer-owned data while preserving a format recognizable by an issuer account management system. For example, the stand alone device may identify the appropriate header or trailer associated with the data and add, delete or modify the data accordingly. The stand alone may manipulate the data using any manipulation instruction or protocol as provided by the data set owner so that the resulting manipulated data is in a format recognizable by the data set owner system. In this way, the stand alone device may manipulate the data while maintaining the data set owner's format. Alternatively, the interaction device may store the issuer-owned data on the transaction device in any format, provided that the issuer-owned data is provided to the issuer system (or to merchant system) in an issuer system (or merchant system) recognizable format.

It should be noted, that one or more transaction devices may be issued with or without one or more data sets stored thereon. The transaction devices may be issued using various techniques and practices now known or hereinafter developed wherein an instrument is prepared (e.g., embossed and/or loaded with data) and made available to a user for effecting transactions. Although the invention may contemplate managing data sets (step 320) before issuing a transaction device (step 310), in various exemplary embodiments, by way of illustration, the data sets are described herein as being managed (step 320) after issuance (step 310).

At any time after issuance (step 310) of one or more transaction devices, a transaction device may be used in a commercial transaction (step 322). In general, the transaction may begin when one or more transaction devices are presented for payment, and are interrogated by an RFID reader. The transaction devices and RFID reader may then engage in mutual authentication after which one or more transaction devices may provide the transponder identification and/or account identifier to the RFID reader which may further provide the information to the merchant system.

As used herein, an RFID reader may be any reader device configured to communicate using a RFID internal antenna and/or an external RFID antenna, where the external antenna may be made remote to the RFID reader using a suitable cable and/or data link. The RFID reader may be further in communication with a merchant system via one or more data links.

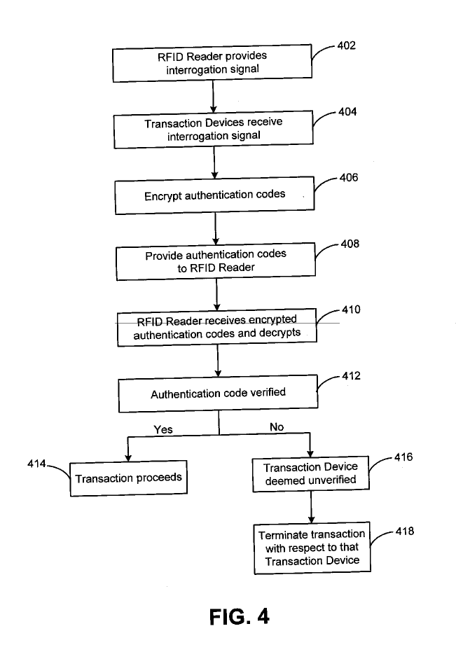

FIG. 4 is a flowchart of an exemplary authentication process in accordance with the invention. The authentication process is depicted as one-sided. That is, the flowchart depicts the process of the RFID reader authenticating one or more transaction devices.

In an exemplary authentication process, where an RFID reader is authenticating one or more transaction devices, the RFID reader may provide an interrogation signal to one or more transaction devices (step 402). The interrogation signal may include a random code generated by the RFID reader, which is provided to the transaction devices and which is encrypted using a unique encryption key corresponding to the transaction devices unique identification codes. The authentication code may be an alphanumeric code which is recognizable (e.g., readable) by the RFID reader and the one or more transaction devices.

One or more transaction devices may receive the interrogation signal (step 404), and thereby be activated by the signal. Once the one or more transaction devices is activated, the interrogation signal, including the authorization code, may be demodulated. The transaction devices may recognize the interrogation signal as a request for authentication, and provide their authentication codes to the reader. In order to provide the authentication codes, the transaction devices may first encrypt their authentication codes (step 406). In particular, the transaction devices may receive their authentication codes and encrypt the codes prior to providing the encrypted authentication codes to the RFID reader (step 408).

The RFID reader may then receive the encrypted authentication codes and decrypt them (step 410). That is, the RFID reader may use one or more authentication keys to decrypt (e.g., unlock) the encrypted authorization code. The authentication keys may be provided to the RFID reader based on the transaction devices' unique identification codes. For example, the encrypted authentication code may be provided by each transaction device to the RFID reader along with the transaction device's identification code.

Once the authentication codes are decrypted, the decrypted authentication codes are compared to the authentication code (interrogation signal) provided by the RFID reader at step 402 (step 412) to verify their authenticity. If a decrypted authorization code is not readable (e.g., recognizable), that specific transaction device is deemed to be unauthorized (e.g., unverified) (step 416) and the operation of the transaction is terminated as to that device (step 418). Contrarily, if the decrypted authorization codes re recognizable (e.g., verified) by one or more transaction devices, the decrypted authorization codes are deemed to be authenticated (step 412), and the transaction is allowed to proceed (step 414). In one particular embodiment, the proceeding transaction may mean that the one or more transaction devices may authenticate the RFID reader prior to the RFID reader authenticating the transaction devices, although, it should be apparent that the RFID reader may authenticate the transaction devices prior to the transaction devices authenticating the RFID reader. Once authentication has been completed, the user may use one or more transaction devices to complete the transaction. For more information on authentication and transactions using an RFID reader, see U.S. patent application Ser. No. 10/340,352, titled “SYSTEM AND METHOD FOR INCENTING PAYMENT USING RADIO FREQUENCY IDENTIFICATION IN CONTACT AND CONTACTLESS TRANSACTIONS,” filed Jan. 10, 2003, incorporated herein, supra.

As stated above, in various embodiments of the invention, the data can be stored without regard to a common format. However, in one exemplary embodiment of the invention, the data set (e.g., BLOB) may be annotated in a standard manner when provided for manipulating the data onto the transaction device. The annotation may comprise a short header, trailer, or other appropriate indicator related to each data set that is configured to convey information useful in managing the various data sets. For example, the annotation may be called a “condition header,” “header,” “trailer,” or “status,” herein, and may comprise an indication of the status of the data set or may include an identifier correlated to a specific issuer or owner of the data. In one example, the first three bytes of each data set BLOB may be configured or configurable to indicate the status of that particular data set (e.g., LOADED, INITIALIZED, READY, BLOCKED, REMOVABLE, or DELETED). Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified merchants are permitted to access the data set for reading, and others are altogether excluded from accessing the data set. However, other access restriction parameters may also be used allowing various entities to access a data set with various permission levels as appropriate.

The data, including the header or trailer may be received from a data set owner via any communication method described herein. The header or trailer may be appended to a data set to be modified, added or deleted, to indicate the action to be taken relative to the data set. The data set owner may provide the data to a stand alone interaction device configured to add, delete, modify, or augment the data in accordance with the header or trailer. As such, in one exemplary embodiment, the header or trailer is not stored on the transaction device along with the associated issuer-owned data but instead the appropriate action may be taken by providing to the transaction device user at the stand alone device, the appropriate option for the action to be taken. However, the invention contemplates a data storage arrangement wherein the header or trailer, or header or trailer history, of the data is stored on the transaction device in relation to the appropriate data.

In various exemplary embodiments, the steps of adding, deleting, augmenting and/or modifying data sets may be repeated. For example, first, second, and additional data sets may be added (step 330) to one or more transaction devices in any order. In one exemplary embodiment of the invention, the first data set is owned by a first data set owner (i.e., first issuer) and the second data set is owned by a second data set owner (i.e., second issuer). Furthermore, the system may include replacing a first data set with a subsequent data set by deleting a data set (step 350), then adding a data set (step 330).

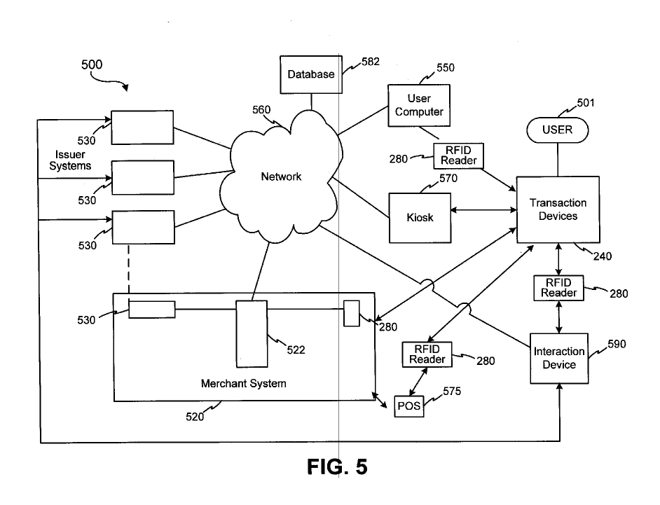

With reference now to FIG. 5, in one exemplary embodiment of the invention, a data set management system (“management system”) 500 comprises a merchant system 520, various issuer systems 530, and one or more transaction devices 240. Management system 500 may further be accessed by a user 501 on a self-service interaction device, such as, for example, user computer 550 or via a transaction device such as, for example, kiosk 570, stand alone interaction device 590, automated teller, or the like. In these examples, communications between user computer 550 or kiosk 570 and merchant system 520 or issuer systems 530 may take place via, for example, a network 560. In various embodiments, merchant system 520, user computer 550 and/or kiosk 570 are configured to communicate with transaction device 240. For example, communication with transaction devices 240 may be facilitated by a merchant RFID reader 280, computer interface, or the like, configured to receive information provided by transaction devices 240.

In general, merchant system 520 is configured to interact with a user 501 attempting to complete a transaction, and to communicate transaction data to one or more of issuer systems 530. Issuer systems 530 are configured to interact with transaction devices 240 to receive and/or exchange data facilitating a transaction. Merchant system 520 may be operated, controlled and/or facilitated by any merchant that accepts payment via a transaction device.

Merchant system 520 is configured to facilitate interaction with user 501, which may be any person, entity, software and/or hardware. User 501 may communicate with the merchant in person (e.g., at the box office), or electronically (e.g., from a user computer 550 via network 560). During the interaction, the merchant may offer goods and/or services to the user 501. The merchant may also offer the user 501 the option of completing the transaction using a transaction device. The merchant system may provide the options to the user 501 using interactive user interface, suitable website or other Internet-based graphical user interface that is accessible by users.

Each user 501 may be equipped with a computing system to facilitate online commerce transactions. For example, the user 501 may have a computing unit in the form of a personal computer (e.g., user computer 550), although other types of computing units may be used including laptops, notebooks, hand held computers, set-top boxes, and/or the like. The merchant system 520 may have a computing unit 522 implemented in the form of a computer-server, although other implementations are possible. The issuer system 530 may have a computing center such as a main frame computer. However, the issuer computing center may be implemented in other forms, such as a mini-computer, a PC server, a network set of computers, or the like.

Issuer system 530 may be configured to manipulate transaction accounts associated with the corresponding issuer-owned data stored on transaction devices 240 (or database 582, discussed below) in accordance with a related transaction. For example, the issuer system 530 may receive “transaction information” and manipulate an account status or balance in accordance with the information received. In accordance with the transaction amount, the issuer system 530 may, for example, diminish a value available for completing a transaction associated with the account, or the issuer system 530 may alter the information relative to the account user (e.g., demographics, personal information, etc.).

It should be noted that issuer systems 530 may also be configured to interact with transaction devices 240, directly or indirectly via database 582 or stand alone interaction device 590, to individually manage data sets on transaction devices 240. For example, issuer systems 530 may manage data sets on database 582. In some embodiments, the data sets on database 582 may then be stored on transaction devices 240 when the transaction devices are presented. In other embodiments, issuer systems 530 may store data set information within their own systems which may communicate with one or more transaction devices via user computer 550, kiosk 570, or merchant system 520. In such embodiments, the issuer system 530 may be configured to push the data set to transaction devices 240 via the stand alone interaction device 590, the merchant system 520, kiosk 570, or computer 250 which may be configured to pull such information from the issuer system 530.

In addition, the data may be manipulated using, for example, a stand alone interaction device 590 configured to communicate with at least one of issuer systems 530 which may or may not be configured to communicate with a merchant system 520. The interaction device 590 may communicate with issuer systems 530 using any of the aforementioned communication protocols, techniques and data links. The communication between the stand alone interaction device 590 and issuer system 530 may be facilitated by a network 560. In an exemplary embodiment, network 560 may be secure against unauthorized eavesdropping.

Interaction device 590 may provide instructions to issuer systems 530 for requesting receipt of issuer-owned data, such as for example, account data, user member identification data, member demographic data, or the like, which the issuer wishes to store on one or more transaction devices 240. Interaction device 590 may communicate with issuer systems 530 using an issuer recognizable communications protocol, language, methods of communication and the like, for providing and receiving data. In one exemplary embodiment, issuer-owned data is received by interaction device 590 from issuer systems 530, and stored onto one or more transaction devices 240. The data may be stored or manipulated in accordance with the issuer provided instructions, protocol, storage format, header or trailers received by the interaction device from issuer systems 530. The issuer-owned data may be stored on transaction devices 240 in any format recognizable by merchant system 520, and further recognizable by issuer system 530. In one exemplary embodiment, the issuer-owned data is stored using a issuer system format which may be later formatted in a merchant system recognizable protocol when provided to merchant system 520. In one embodiment, the issuer-owned information is stored on transaction devices 240 in the identical format with which it was provided by issuer system 530. In that regard, interaction device 590 may be any device configured to receive issuer-owned data from issuer system 530, and write the data to a database, such as, for example, a database on transaction devices 240 or database 582. Further, as described more fully below, the issuer-owned information may also be provided by issuer system 530 to remote database 582 where the information is stored such that it mirrors the corresponding information stored on transaction devices 240.

Interaction device 590 may be initialized prior to use. For example, interaction device 590 may be any system which may be initialized (“configured”) to communicate with merchant system 520. Where the interaction device is not initialized prior to attempting communications with merchant system 520 or transaction devices 240, interaction device 590 may be initialized at merchant system 520 location. Interaction device 590 may be initialized using any conventional method for configuring device communication protocol.

As noted, in accordance with the invention one or more transaction devices are provided which permit the storage and presentment of at least one of a plurality of data sets for completing a transaction. The data sets may be stored on the transaction devices themselves, or on a remote database, as described below. The data sets stored with regard to transaction device may be modified, deleted, added or augmented, as required by the issuer or the user. For example, as owner of the data, an issuer may modify a data set at the issuer's discretion. The issuer may modify the data, data subsets, member identifier and/or applications or data sets associated with its transaction account program. Such modifications may be completed or substantially completed in substantially real-time or at a later date, for example, when the transaction devices are next presented.

In a typical example of issuer modification of the data sets, one or more data sets may be modified by issuer system 530 directly via issuer systems 530, upon presentment of transaction devices 240 to system 230. That is, user 501 may present the card to issuer system 530, and issuer system 530 may modify the issuer data stored thereon, using any issuer defined protocol. Alternatively, the modifications, or instructions for modification, may be initiated at issuer system 530, and provided to network 560. The modifications and/or modification instructions may additionally be provided to a suitable device configured to communicate with transaction devices 240, receive information regarding the data stored on transaction devices 240, and to write or overwrite the information contained on transaction devices 240. For example, as noted, interaction device 590 is a suitable interaction device which may be used to provide information to transaction devices 240 to modify the information stored thereon. Interaction device 590 may be any device capable of receiving data management instructions from issuer systems 530 and for updating the data stored on transaction devices 240, in accordance with the instructions received. In this regard, interaction device 590 may include any electronic components, databases, processors, servers and the like which may be used to modify the data stored on transaction devices 240 using any suitable data modification protocol as is found in the art. Preferably, the interaction device is configured to modify the data on the transaction devices in accordance with a data owner defined protocol.

In one exemplary embodiment, interaction device 590, may be configured to modify transaction devices' 240 issuer-owned data when transaction devices 240 are initially configured, prior to providing transaction devices 240 to user 501. Interaction device 590 may additionally be configured to modify the issuer data on transaction devices 240 when transaction devices 240 are next presented, for example, to the stand alone interaction device 590. In this regard, interaction device 590 may receive from multiple distinct issuer systems 530, via network 560, the issuer provided modifications/instructions and may update transaction devices 240 in real-time or substantially real-time. The modifications may be provided to interaction device 590 for storage and later use when transaction devices 240 are next presented. Alternatively, interaction device 590 may be configured to retrieve the instructions from issuer system 530 when transaction devices 240 are next presented to device 590. Further, where other devices, such as, for example, a kiosk 570, merchant point-of-sale device, or the like, are likewise configured to modify the issuer data on transaction devices 240, the invention contemplates that the real-time or substantially real-time modifications noted above may be made using those devices in a similar manner as is described with interaction device 590.

Alternatively, the device to which transaction devices 240 may be presented, may not be equipped for updating or modifying the data stored on transaction devices 240. For example, merchant system 520 may be any conventional merchant system which communicates to issuer system 530, and which permits user 501 to complete a financial transaction, but which is not configured to modify the issuer data contained on transaction devices 240. In general, conventional merchant systems are not configured to write or overwrite data included on the payment devices presented to the merchant system for processing. That is, merchant system 520 may include little or no additional software to participate in an online transaction supported by network 560. Management of the data sets on transaction devices 240 may be performed independent of the operation of merchant system 520 (e.g., via issuer system 530 or interaction device 590). As such, the invention may require no retrofitting of merchant system 520, to accommodate system 500 operation. Thus, where merchant system 520 is not configured to modify the data on transaction devices 240, such modifications may be made as described above with respect to modifications being made at interaction device 590 or by the issuer at issuer system 530.

Merchant system 520, kiosk 570, and/or interaction device 590, may include additional means for permitting user 501 to self-manage the data stored on transaction devices 240. In this case, systems 520, 570, and 590 may include an additional user interface for use by user 501 to identify the modification action to be taken. Where systems 520, 570, and 590 are configured to communicate with transaction devices 240 and to modify the data thereon, the modifications may be completed or substantially completed in real-time or substantially real-time. For example, user 501 may present transaction devices 240 to one of systems 520, 570, and 590, provide instructions to systems 520, 570, and 590 for modifying the data on transaction devices 240. The instructions may include, for example, “ADD,” “DELETE,” MODIFY,” and systems 520, 570, and 590 may modify the data stored on transaction devices 240 in accordance therewith. The modifications may be made on the instrument in real-time or substantially real-time, for example, prior to permitting transaction devices 240 to be used by user 501. Alternatively, the modifications or instructions for modification may be provided by user 501 to merchant system 520 or kiosk 570, and merchant system 520 or kiosk 570 may further provide the modifications/instructions to network 560 for use in later modifying the data. For example, the modifications/instructions may be provided by system 520 or 570 to issuer system 530 managed by the issuer owning the data to be modified. Issuer system 530 may provide the modifications to, for example, interaction device 590, for updating transaction devices 240 when next presented. The modifications/instructions may additionally be provided from network 560 to a remote database, where the issuer-owned data corresponding to the transaction device and the issuer may be additionally stored (i.e., database 582, described below). In one exemplary embodiment, the modifications/instructions may be stored at issuer system 530, until such time as transaction devices 240 are next presented to a device configured to modify the data on the instrument. Once presented, the modifications/instructions may be provided to the device (e.g., computer 550, interaction device 590, etc.) for modifying transaction devices 240 data.

In another exemplary embodiment, user 501 may self-manage the data sets by, for example, modifying the data sets using a conventional computer system 250, which may be in communication with network 560. Computer system 250 may or may not be configured to interact with transaction devices 240. Where the computer system 250 is not configured to interact with transaction devices 240, user 501 may provide modifications or instructions to issuer system 530 for later use in modifying the corresponding transaction devices 240 data, for example, when transaction devices 240 are next presented in a similar manner as described above. Where the computer 550 is configured to interact with transaction devices 240 to modify the data stored thereon, user 501 may provide modifications/instructions to the computer 250 for modifying the data on the financial instrument in real-time or substantially real-time. That is, computer 550 may be configured to interact with, read, add, delete, and/or modify the data sets on transaction devices 240. Consequently, the computer 550 may receive modifications/instructions from user 501 and perform the modifications accordingly, and may modify the data in real-time or substantially real-time. The computer 550 may additionally be configured to receive authorization of the modifications/instructions from issuer system 530 prior to making user 501 requested changes. In one exemplary arrangement, user 501 may provide the modifications/instructions via network 560 which may be additionally provided to issuer system 530. Issuer system 530 may receive user 501 modifications/instructions and verify whether the identified updates are available to user 501 or if the identified updates are valid. If the identified updates are authorized, issuer system 530 may update a data storage area associated with transaction devices 240. For example, issuer system 530 may update an issuer database (not shown) containing data corresponding to the issuer-owned data associated with transaction devices 240. Alternatively, issuer system 530 may provide modifications/instructions to a database positioned remotely to issuer system 530 for use in modifying the data stored thereon, which is associated to one or more transaction devices 240. As such, in accordance with the invention, user 501 may self-manage the data via, for example, the user computer 550, a kiosk 570, a merchant system 520, and/or a stand alone interaction device 590.

In one exemplary method of self-management, user 501 logs onto a website via user computer 550, or onto a stand alone device, such as, for example, interaction device 590 or kiosk 570, and selects options for configuring data sets on one or more transaction devices 240. The changes may be transmitted to transaction devices 240 via RFID reader 280 configured to communicate the data to transaction devices 240. In this context, RFID reader 280 may be any conventional transaction device reader or writer.

As noted, modifications to the data stored on transaction devices 240 may be made in real-time or substantially real-time when transaction devices 240 are presented to interaction device 590, or to RFID reader 280. However, as noted, various embodiments of the invention include a remote database 582 in communication with an issuer system 530 via a network 560. The remote database 582 may additionally be in communication with one of the user computer 550, kiosk 570, merchant system 520 and/or interaction device 590, for variously receiving modifications or instructions for performing modifications to the data stored thereon. In addition, database 582 may contain a data storage area which “mirrors” the data stored on transaction devices 240. In this context “mirrored” or “mirror” may mean that the data is stored on database 582 in substantially identical configuration and format as that stored on transaction devices 240. As such, the invention may be configured to permit modifications made to transaction devices 240 data to be mimicked on corresponding data locations on database 582. For example, user 501 may self-manage the data on the database 582 via a user interface in communication with the database 582 via network 560. In one exemplary embodiment, user 501 may communicate with a “website” which is used to manage the database 582, wherein database 582 is a database including unique locations for storing the issuer provided data and data sets correlative to the data and data sets stored on transaction devices 240. The website may include an account management application which permits user 501 to select which user accounts to add, delete, or modify with respect to transaction devices 240. That is, user 501 may provide unique identifying information to the user computer 550 which may be recognized by the system (e.g., issuer system 530 or remote system managing the database 582) managing database 582, thereby permitting user 501 to access the data corresponding to the unique identifying information stored on database 582. Further, prior to permitting modifications to the database 582, the issuer owning the data may require authorization that such modifications may be performed. Further still, the invention contemplates that database 582 may be self-managed by user 501 in a similar manner, where merchant system 520, kiosk 570 and/or interaction device 590 are configured to provide modifications/instructions to issuer systems 530 and database 582.

In another exemplary embodiment, database 582 serves as a temporary or redundant storage space for data sets. Thus, a “mirror image” of the data sets currently on transaction devices 240 may be maintained and/or updated at appropriate intervals for facilitating replacement of, for example, a damaged transaction device 240. As such, database 582 may be used, for example, for verifying the validity or accuracy of the information stored on transaction devices 240. Also, changes to one or more data sets may be stored to database 582 pending an opportunity to update transaction devices 240. In various embodiments, such updating may take place in both directions similar to hot sync technology.

As noted, in some exemplary embodiments of the invention, authorization must be obtained from issuer systems 530 prior to making any modifications to the data contained on transaction devices 240 or database 582. Authorization may be obtained by requesting the authorization during the modification process. Authorization may be given where user 501 provides the more appropriate security information, which is verified by issuer system 530. The security information may be, for example, a security code granting access to the issuer-owned data on transaction devices 240 or database 582. For example, a point-of-sale (POS) machine may be configured to allow the input of a code, or an answer to a prompt which is provided to and verified by issuer system 530. Once verified the modification requested may be made to the data contained on transaction devices 240.

It should be noted that the authorization code may be used to permit user 501 to select which issuer provided data to utilize for completion of a transaction. For example, a Point-of-Sale device (POS) device may be programmed to search transaction devices 240 for a data set containing a particular club membership data set, or to locate all available data sets for providing to user 501, display available data sets to user 501, thereby permitting user 501 to select which data set to use to complete a transaction. If no data set is found, the POS device may alert user 501 or prompt the merchant to alert user 501 of the possibility of adding issuer-owned data to transaction devices 240. A positive response to this alert may cause the POS device to add an issuer data set to one or more transaction devices 240.

It is noted that user 501 may already be a member of a membership program managed by an issuer system 530 in which case the associated user 501 membership data may be assigned to user 501 for inclusion on transaction devices 240. As such, user 501 may be permitted to add the membership data set to transaction devices 240. Alternatively, the user may become a member by selecting to add the membership information to transaction devices 240, using the interactive device 590. In some embodiments, changes made to the data sets stored on transaction devices 240 may be updated to transaction devices 240 in real-time or substantially real-time, where the device 290 is in communication with transaction devices 240. Or the changes may be made the next time user 501 presents transaction devices 240 to stand alone interaction device 590 or to a kiosk 570, merchant system 520, or the like.

In another exemplary embodiment of the invention, merchant system 520, kiosk 570, and/or user computer 550 may be configured to interact with transaction devices 240 via RFID reader 280. RFID reader 280 may be any device configured to communicate with financial transaction 240. In one embodiment, RFID reader 280 is configured to read and write to transaction devices 240. For example, where transaction devices 240 include a RF transmitter/receiver for communicating with system 500, RFID reader 280 may include one or more mating transponder configured to receive and transmit issuer-owned data. RFID reader 280 may be configured to select data sets for use by a merchant using any suitable selection technique including but not limited to proprietary commands or command sequences or use of ISO/IEC 7816-4 application selection sequences (e.g., GET command).

In one exemplary embodiment, management of data sets is facilitated by annotating the data set with a status indicator (e.g., condition header); (e.g., LOADED, INITIALIZED, READY, BLOCKED, REMOVABLE or DELETED).

In this regard, a data set may have a LOADED status when the information related to that data set has been stored in association with transaction devices 240, but remains dormant. For example, a credit card account may have been added to one or more transaction devices 240 that has not yet been activated. In some instances, the loaded data set needs to be further configured before it is ready to be used. For example, the data set may be modified to include a particular branch in a chain of franchise stores, the identification of a user's 501 primary care physician, or to reflect a user's 501 selection of a platinum membership status. In another example, a loyalty program may be added in association with one or more transaction devices 240, and the data set marked LOADED. In another example, user 501 may interact with a kiosk 570 or the like to input personal information and configure the loyalty program data set. Once such a data set has been configured, it may be annotated with an INITIALIZED status.

The status of a data set may be set as READY when the data set is ready to be utilized. For example, user 501 may enter a secret code to indicate that user 501 is ready to use the data set. In one example, the data set may be marked as READY when that data set is first accessed to perform a transaction. It will be noted that in accordance with other embodiments of the invention, the status of a data set may be set at READY the moment it is loaded to one or more transaction devices 240. Furthermore, it is possible to change the status between READY, LOADED, and INITIALIZED, under appropriate circumstances. Thus, the data sets may be managed through any one or more of these states and in various orders.

It may also be desirable to prevent use of a data set and/or the associated functionality for a period of time. Thus, the status indicator may be set to BLOCKED. The setting of the status indicator to BLOCKED may, for example, disable the use of the data set. In one exemplary embodiment, an appropriately configured transaction device reader is configured to recognize the BLOCKED status indicator when accessing the data set and to prevent use of that data set example.

In addition, for various reasons, user 501 may desire to remove a data set from one or more transaction devices 240. User 501 may, for example, desire to use the available space on one or more transaction devices 240 for other data sets, or may remove the data set for security reasons. Furthermore, circumstances may arise where the owner of the data set desires to remove the data set from one or more transaction devices 240, such as when a coupon expires. In these instances, the data set may be marked as REMOVABLE. Under these circumstances, the memory associated with the data set is available to receive information associated with future added data sets, but for the moment retains the old data set. A REMOVABLE data set may again be made READY under various configurations.

The REMOVABLE data set may subsequently be removed from a transaction device 240 and marked DELETED. A DELETED status indicator may be used to indicate that a portion of a transaction device 240 is available to store one or more data sets. It is noted that data sets may be directly deleted without going through the step of making the data set REMOVABLE. In one example, a data set may be removed from a transaction device 240 if the security of the account associated with the data set is compromised (e.g., stolen password). Furthermore, as appropriate, the status of data sets may be changed to different states. Under appropriate circumstances one or more of any of the six status indicators LOADED, INITIALIZED, READY, BLOCKED, REMOVABLE, or DELETED or other suitable status indicators may be used to annotate a BLOB or other similar data sets.

Although the data sets described herein may be managed without status indicators, nevertheless, such status indicators facilitate management of data. For example, regardless of a first data set owner's ability to interpret the information stored in a data set owned by another party, the first owner may interpret the status indicator to determine whether the data set is LOADED, DELETED, or the like. The determination that a data set is DELETED facilitates the addition of new data sets by independent owners without overwriting other data sets on transaction devices 240. In addition, the use of tags or status indicators may facilitate the use of global rules, which may simplify operations and/or commands. Status indicators may also enhance interoperability between data sets. Nevertheless, a data set owner may chose not to use a status indicator even if the opportunity is available.

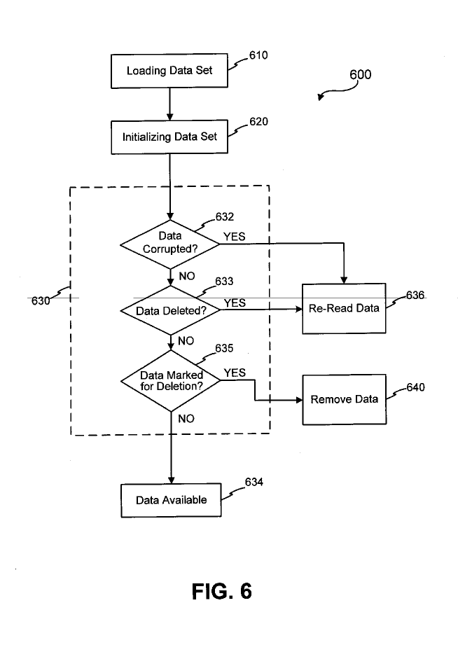

Managing of the data sets (step 320) may include one or more of the following exemplary steps: add, update, modify, replace, verify, delete and/or the like. More particularly, FIG. 6 illustrates a general overview of an exemplary data set management method 600 comprising the steps of: loading a data set (step 610), initializing a data set (step 620), verifying availability of data set (step 630), and deleting a data set (step 640). In this manner, a data set may be added to one or more transaction devices 240 and utilized until it is deleted. The ability to update, modify, replace and/or delete a data set may be subject to security requirements.

In one embodiment, the various processes may include user 501 facilitating the input of information into a data management system to cause the data set to be loaded. The information may be inputted via keypad, electronic pointer, touchpad and/or the like, into user computer 550, POS terminal, kiosk 570, ATM terminal and/or directly into merchant system 520 via a similar terminal or computer associated with merchant server 522. The information may be transmitted via any network 560 discussed herein to merchant system 520 or issuer systems 530. In another embodiment, the merchant may enter the information into issuer system 530 on behalf of user 501. This may occur, for example, when user 501 and/or issuer system 530 authorizes the management of data sets on one or more transaction devices 240 over a telephone and the service representative inputs the information. In this embodiment, transaction devices 240 may be updated at the next presentment opportunity such as when user 501 attempts to compete a transaction using one or more transaction devices 240.

Any suitable procedures may be utilized to determine whether a data set is currently ready for use and available (step 630). In one example, when one or more transaction devices 240 are presented, the availability of the data set is verified by checking whether the data set has been corrupted or blocked (step 632), or deleted (step 633). For example, the data set may be checked to determine if the data set has been accessed or altered without permission (“corrupted”) or if the data set exists or has been removed from transaction devices 240 (“deleted”). The check may be performed using any suitable protocol or comparing data. If the answer to these questions is no, then the data set is available and ready for use (step 634). If the data is corrupted or blocked, subroutines may be used to attempt to retry reading the data (step 636). If the data set is marked deleted or removable, subroutines will prevent access to the data set (step 635) and remove the data set (step 640). For example, a suitable subroutine may place a DELETE “marker” on the data set which prevents the data from being transmitted during completion of a transaction. The data set may then be marked for deletion and deleted from transaction devices 240 at the next presentment of the device. In a similar manner, where the data set is corrupted, a CORRUPTED marker may be appended to the data set and the data set is prevented from being transmitted during completion of a transaction. The marker may be a header or trailer as discussed herein.

Information may also be added or deleted from one or more transaction devices 240. For information on adding and/or deleting data sets, see U.S. patent application Ser. No. 10/711,720, titled “Systems and Methods for Managing Multiple Accounts on a RF Transaction Device Using Secondary Identification Indicia, filed Sep. 30, 2004, incorporated herein, supra.

In an exemplary embodiment, management of the data sets may further include selecting preferences for use of the data sets. For example, user 501 may indicate a desire to use data set A, associated with a low interest rate credit card, as a first option, but to use data set B, associated with a higher interest rate credit card when data set A is not available. In another example, one data set may be used for purchases of gas while another data set may be used for purchasing travel tickets. The consumer data set preferences may be stored on transaction devices 240 as a data set. In this example, when the device is presented, all available data sets are read and the RFID reader device determines which data sets are to be used based in part on the preferences stored on the device, which preferences may be updated from time to time.

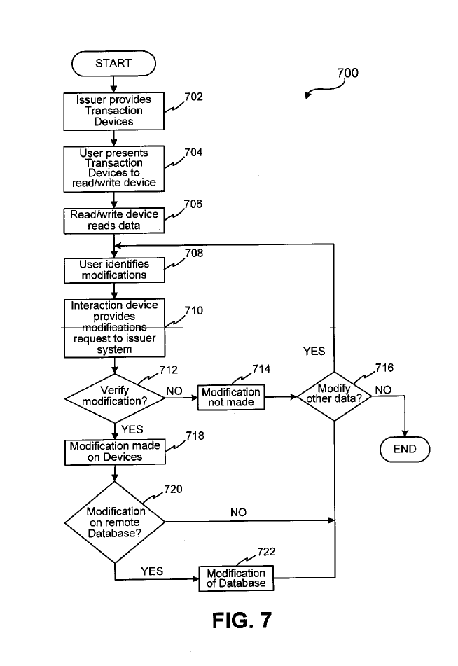

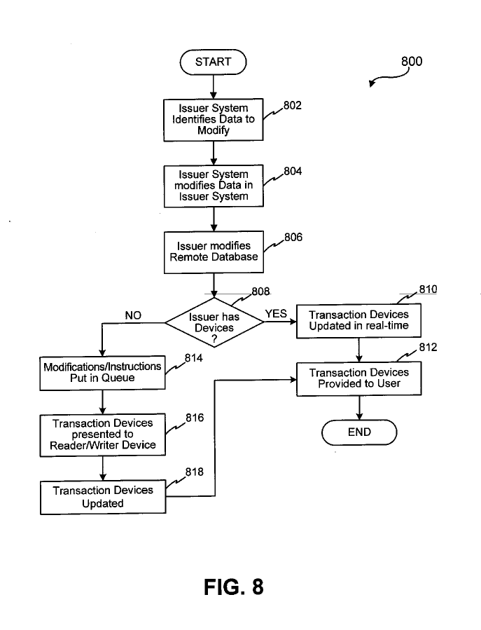

As noted, the data associated with transaction devices 240 may be modified by user 501 and/or by issuer system 530. FIGS. 7 and 8 respectively, depict exemplary methods for user 501 and issuer system 530 data management. For example, with respect to user 501 self-management, issuer system 530 may provide user 501 with one or more transaction devices 240 (step 702). Transaction devices 240 may be provided with pre-stored issuer-owned data, or transaction devices 240 may be configured to permit user 501 to add the data at a later date. User 501 may present transaction devices 240 to RFID reader 280 for initiating the self-management process (step 704). RFID reader 280 may then read the data on transaction devices 240, and provide the data to an interaction device 590 for displaying to user 501 (step 706). Alternatively, interaction device 590 may provide user 501 a list of available data to be added to transaction devices 240.

User 501 may then be permitted to identify which data set user 501 wishes to modify (step 708). Identification of the data may include providing the data with a trailer or header indicating the action to be taken (e.g., add, delete, augment, overwrite, etc.). The header and an indicator of the data to be modified may then be provided to issuer system 530 (step 710) for verification as to whether such desired modifications are available to user 501 (step 712). If the desired modifications are not available, the modifications will not be made and user 501 is notified accordingly (step 714). User 501 may then be permitted to identify whether other data is to be modified (step 716). If so (step 708), interaction device 590 may provide a request for modification to the issuer system 203 (step 710) and the verification process is repeated.

Alternatively, where issuer system 530 verifies that the modifications may be made (step 712), interaction device 590 may make the modifications to the appropriate data on transaction devices 240 (step 718). Additionally, where the system 500 includes a remote database 582 for storing a mirror image of the data contained on transaction devices 240 (step 720), interaction device 590, or issuer system 530, may facilitate modification of the remote database 582 (step 722). User 501 may then be permitted to select other data sets to modify (step 716), in a similar manner as was described above.

In either case, where the modifications are complete, user 501 may then present transaction devices 240 to a merchant for use in completing a transaction.

In accordance with the invention, transaction devices 240 may include multiple transaction account numbers stored on RFID transaction device database 112 (or secure memory 116). Each transaction account number stored thereon may be associated with a distinct PIN and/or other secondary identifier for use by merchant system 520, issuer system 530 or any other third party in verifying or authorizing a transaction. For example, a first transaction account number (e.g., first data set) may be associated with a first PIN and/or other secondary identifier on issuer system 530 or on the transaction device database 112, 116, and a second transaction account number (e.g., second data set) may be associated with a second PIN and/or other secondary identifier on issuer system 530 or on the transaction device database 112, 116, where the first transaction account number is distinct and different from the second transaction account number and the first PIN and/or other secondary identifier is distinct and different from the second PIN and/or other secondary identifier.

Upon presentment of transaction devices 240 to RFID reader 280 for transaction completion, transaction devices 240 may provide RFID reader 280 with information relative to the multiple transaction account numbers which may be contained in the transaction device database 112, 116. RFID reader 280 may then inform user 501 that multiple transaction accounts are available on the transaction device database 112, 116 for use in transaction completion. RFID reader 280 may notify user 501 audibly, for example, by reciting specific information relative to each transaction account number. For example, RFID reader 280 may audibly notify user 501 that a particular transaction account number is one issued by a particular issuer system 530. RFID reader 280 may request that user 501 select at least one of the transaction accounts contained on the database 112, 116 for use in transaction completion. Methods for using secondary identification to select transaction accounts are described in greater detail below.

FIG. 8 depicts an exemplary method wherein issuer system 530 manages the data contained on transaction devices 240. For example, the issuer may identify on issuer system 530 which data sets are to be modified (step 802). The modifications may then be made to the corresponding data set stored on issuer system 530 (step 804). Where the system 500 includes a remote database 582, issuer system 530 may provide the modifications/instructions to the database 582 for updating the database 582 accordingly (step 806).

In addition, issuer system 530 may query as to whether issuer system 530 is in possession of one or more transaction devices 240 for making the modifications to the data set on transaction devices 240 in real-time or substantially real-time (step 808). If so, the modifications are made accordingly (step 810) and transaction devices 240 may then be provided to user 501 for use in completing a transaction using the distinct data sets modified (step 812).

Where issuer system 530 is not in possession of one or more transaction devices 240 at the time the issuer determines that modifications to the data on one or more transaction devices 240 are to be made (step 808), the modifications may be made on issuer system 530 (step 804), and may be placed in queue, for uploading to transaction devices 240 when they is next presented to issuer system 530 or to an appropriate RFID reader 280 (step 814). When transaction devices 240 are presented thusly (step 816), issuer system 530 may be notified that transaction devices 240 are available for modifying, and issuer system 530 may then provide the instructions for modification (e.g., modified data including headers) to the appropriate RFID reader 280 for modifying transaction devices 240 (step 818). Transaction devices 240 may then be provided to user 501 for use in completing a transaction (step 812).

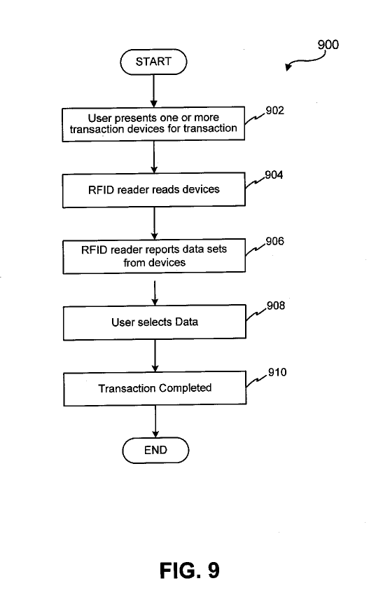

As noted, transaction devices 240 may include multiple data sets which correspond to distinct issuer systems 530, and which may be used to complete a transaction. User 501 may be permitted to choose which data set to use for transaction completion. FIG. 9 illustrates an exemplary method by which user 501 may choose which of the data sets to use to complete a transaction. For example, user 501 may present one or more transaction devices 240 to a merchant system 520 for use in completing a transaction (step 902). That is, RFID reader 280, in communication with merchant system 520, may read the data stored on one or more transaction devices 240 (step 904) and then RFID reader 280 reports to user 501 all distinct data sets which may be used to complete a transaction (step 906). RFID reader 280 may be configured to report the data sets to user 501 on a user-interface, PIN pad, computer screen, terminal, and/or any other communication device that is coupled to RFID reader 280 by one or more data links. User 501 may then select the appropriate data set using the communication device (step 908) and the transaction is completed accordingly (step 910).

By selecting the appropriate data set, user 501 may be requested to enter or present a secondary indicia, account or code (defined herein). For example, in one embodiment, the invention permits the system user 501 to present one or more transaction devices 240 containing multiple distinct data sets, and to select a particular data set for transaction completion. User 501 may select a particular data set using any form of secondary identification, such as, for example, a personal identification number (PIN), biometric identifier, voice recognition technology, retinal recognition technology, or the like. The secondary identifier may be provided to the communication device (i.e., merchant point-of-sale device 575, kiosk 570, RFID reader 280, or the like) for transaction completion.

In yet another embodiment, the transaction devices 240, RFID reader 280, and/or transponder-reader system are configured with a biometric security system that may be used for providing biometrics as a secondary form of identification. A biometric system may include one or more technologies, or any portion thereof, such as, for example, recognition of a biometric. The biometric security system may be configured with one or more biometric scanners, processors, sensors and/or systems to facilitate detecting and/or verifying biometric samples. As used herein, a biometric and/or biometric sample may include a user's voice, fingerprint, facial, ear, signature, vascular patterns, DNA sampling, hand geometry, sound, olfactory, keystroke/typing, iris, retinal or any other biometric relating to recognition based upon any body part, function, system, attribute and/or other characteristic, or any portion thereof. For an explanation of systems and methods for providing a secondary form of identification for transaction completion, see U.S. Pat. No. 4,508,186, issued Apr. 2, 1985, to Omura et al.; U.S. Pat. No. 4,975,969, issued Dec. 4, 1990, to Tal; U.S. Pat. No. 6,213,391, issued Apr. 10, 2001, to Lewis; U.S. patent application Ser. No. 10/708,822, titled “SYSTEM FOR BIOMETRIC SECURITY USING A transaction device,” filed Mar. 26, 2004; U.S. patent application Ser. No. 10/708,823, titled “METHOD FOR BIOMETRIC SECURITY USING A TRANSPONDER,” filed Mar. 26, 2004; U.S. patent application Ser. No. 10/708,823, titled “METHOD FOR BIOMETRIC SECURITY USING A TRANSPONDER,” filed Mar. 26, 2004; U.S. patent application Ser. No. 10/708,824, titled “Method for Biometric Security using a Transponder-Reader,” filed Mar. 26, 2004; U.S. patent application Ser. No. 10/708,825, titled “Method and System for Fingerprint Biometrics on a Fob,” filed Mar. 26, 2004; U.S. patent application Ser. No. 10/708,826, titled “Method and System for Facial Recognition Biometrics on a Fob,” filed Mar. 26, 2004; U.S. patent application Ser. No. 10/708,827, titled “Method and System for Voice Recognition Biometrics on a Fob,” filed Mar. 26, 2004; U.S. patent application Ser. No. 10/708,828, titled “Method and System for Signature Recognition Biometrics on a Fob,” filed Mar. 26, 2004; U.S. patent application Ser. No. 10/708,829, titled “Method and System for Vascular Pattern Recognition Biometrics on a Fob,” filed Mar. 26, 2004; U.S. patent application Ser. No. 10/708,830, titled “Method and System for DNA Recognition Biometrics on a Fob,” filed Mar. 26, 2004; U.S. patent application Ser. No. 10/708,831, titled “Method and System for Hand Geometry Recognition Biometrics on a Fob,” filed Mar. 26, 2004; U.S. patent application Ser. No. 10/708,832, titled “Method and System for auditory emissions Recognition Biometrics on a Fob,” filed Mar. 26, 2004; U.S. patent application Ser. No. 10/708,833, titled “Method and System for Smellprint Recognition Biometrics on a Fob,” filed Mar. 26, 2004; U.S. patent application Ser. No. 10/708,834, titled “Method and System for Keystroke scan Recognition Biometrics on a Fob,” filed Mar. 26, 2004; U.S. patent application Ser. No. 10/708,835, titled “Method and System for Iris Scan Recognition Biometrics on a Fob,” filed Mar. 26, 2004; U.S. patent application Ser. No. 10/708,836, titled “Method and System for Retinal Scan Recognition Biometrics on a Fob,” filed Mar. 26, 2004; U.S. patent application Ser. No. 10/708,837, titled “SYSTEM AND METHOD FOR PROFFERING MULTIPLE BIOMETRICS FOR USE WITH A transaction device,” filed Mar. 26, 2004; U.S. patent application Ser. No. 10/708,838, titled “System for Registering a Biometric for Use with a Transponder,” filed Mar. 26, 2004; U.S. patent application Ser. No. 10/708,839, titled “Method for Registering Biometric for Use with a Fob,” filed Mar. 26, 2004; U.S. patent application Ser. No. 10/708,840, titled “Method for Using a Sensor Register a Biometric for Use with a transponder-reader system,” filed Mar. 26, 2004; U.S. patent application Ser. No. 10/708,841, titled “Biometric safeguard for Use with a fob,” filed Mar. 26, 2004; all of which are herein incorporated by reference.

It should be noted that completion of a transaction may be performed under any business as usual standard employed by the merchant and/or issuer system 530. For example, merchant server 522 may be configured to communicate transaction data to the appropriate issuer system 530, in real-time or substantially real-time, or by using batch processing at the end of each day. Any suitable means for delivering the transaction data to issuer systems 530 may be used. In one exemplary embodiment of the invention, the transaction data may be delivered to issuer system 530 via a network 560. Issuer system 530 may receive the transaction information and process the transaction under issuer defined protocol independent of any other protocol used by other issuers to process a transaction. Issuer system 530 may receive the transaction data and provide the merchant with the appropriate satisfaction for the transaction.

In step 808, described above, issuer system 530 may require user 501 to provide a secondary form of identification prior to authorizing a transaction. For example, issuer system 530 may receive a transaction request from a merchant system 520, and return instructions to merchant system 520 to prompt user 501 to provide a PIN or other secondary identifier. The merchant system POS 575 may require user 501 to provide the secondary identifier prior to further processing the transaction request. User 501 may provide the secondary identifier to merchant system 520 using, for example, a conventional keypad as is commonly used in the industry for such purposes. Once the secondary identifier is provided to merchant system 520, merchant system 520 may provide the secondary identifier and any other information used to identify user 501 to issuer system 530 for secondary identifier verification.

The conventional secondary identifier verification process performed by issuer system 530 may include comparing the secondary identifier to a secondary identifier stored in the issuer system database with reference to the user's account number. If the secondary identifier provided by user 501 matches the secondary identifier stored correlative to the user account number on issuer system 530, then issuer system 530 may authorize completion of the merchant's transaction request. Otherwise, issuer system 530 may deny transaction authorization.

Notably, issuer system 530 may use any issuer defined protocol to compare the provided secondary identifier to the secondary identifier stored in the issuer database. For example, the secondary identifier may be manipulated by issuer system 530 using any suitable algorithm or any additional information obtained from merchant system 520, user 501, or the issuer system database, and the results of the manipulation may be analyzed, or verified against any other information stored on the issuer system database. As such, the method by which issuer system 530 verifies the secondary identifier is not limited. Any issuer system 530 defined method may be suitably employed.

In other conventional transaction processing systems, the secondary identifier may be verified by merchant system 520. Merchant system 520 may receive the transaction account number from transaction devices 240 upon initiation of a transaction by user 501. Merchant system 520 may receive the transaction account number and recognize that user 501 may need to provide a secondary identifier to merchant system 520 for verification prior to completion of the transaction. Merchant system 520 may provide user 501 with a request for the secondary identifier, or with notification that a secondary identifier is required to complete the transaction. User 501 may then provide the secondary identifier to merchant system 520 using, for example, a conventional keypad. Merchant system 520 may receive the secondary identifier from user 501 and provide the secondary identifier to transaction devices 240. According to this secondary identifier verification method, the transaction device database includes a user secondary identifier against which transaction devices 240 may compare the secondary identifier provided by user 501 via merchant system 520. If the secondary identifier provided by user 501 matches the secondary identifier stored in the transaction device database, merchant system 520 may then forward the merchant's transaction request to issuer system 530 for completion. Otherwise, merchant system 520 may deny the transaction.

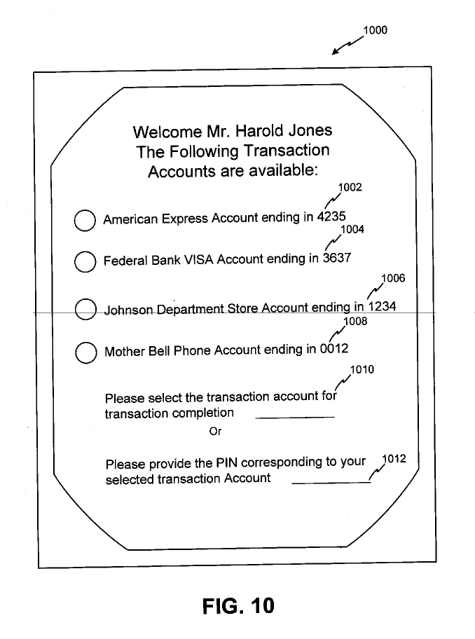

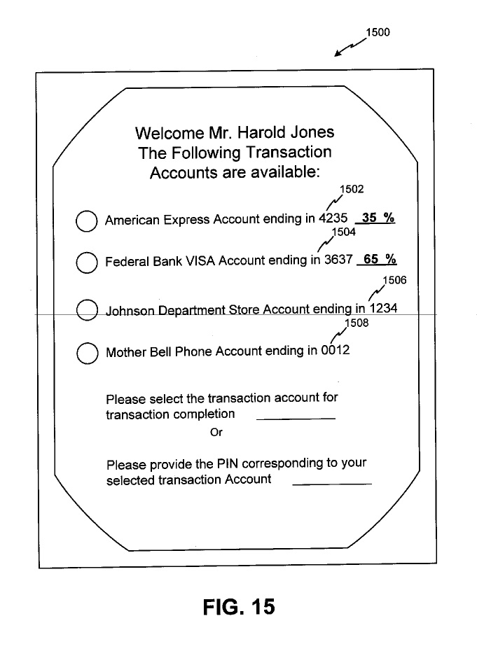

In another exemplary embodiment, RFID reader 280 (or merchant system 520) may be configured to provide to the user a listing of the multiple transaction accounts contained on the database 112. In this exemplary embodiment, RFID reader 280 (or merchant system 520) may be equipped with a display screen (not shown) for displaying the multiple accounts to user 501. FIG. 10 depicts an exemplary screen shot 1000 of a display screen that may be presented to user 501 for transaction account selection. Screen shot 1000 may include a listing of transaction account numbers 1002-1008, which may correspond to the transaction account numbers (e.g., data sets) stored on the transaction device database 112,116 and/or to each specific transaction device 240 (see FIG. 15). For example, transaction account number 1002 corresponds to a first transaction account number (e.g., “American Express Account ending in 4235”); transaction account number 1004 corresponds to a second transaction account number (e.g., “Federal Bank VISA Account ending in 3637”); transaction account number 1006 corresponds to a third transaction account number (e.g., “Johnson Department Store Account ending in 1234”); and transaction account number 1008 corresponds to a fourth transaction account number (e.g., “Mother Bell Phone Account ending in 0012”).

User 501 may then be prompted by message 1010 to select which one of the transaction account numbers to use in completing the transaction. For example, user 501 may be prompted by a message 1012 to provide a PIN corresponding to the transaction account number selected. The PIN may be provided to merchant system 520 via a keypad, touch screen, or the like. The PIN may then be verified in accordance with any method described above. If the PIN is verified, the transaction may be completed under business as usual standards. Otherwise, completion of the transaction is denied.

In another exemplary embodiment, user 501 may be permitted to select a transaction account number from the screen. User 501 may be permitted to select a particular transaction account number by providing transaction account identifying information to merchant system 520. For example, where the screen is a touch sensitive screen, user 501 may select a particular transaction account by touching the appropriate transaction account on the screen 1000, or by providing transaction account identifying information to the screen in accordance with the message 1010 provided by to user 501. In some instances, user 501 may select a particular transaction account by providing merchant system 520 with a PIN which correlates with the selected transaction account. As such, issuer system 530 or merchant system 520 may verify whether a PIN is required to complete the transaction using the transaction number selected. The PIN may be verified under any merchant system 520 or issuer system 530 defined protocols. If a PIN is required, then user 501 may be prompted to provide the required PIN to the keypad prior to completing the transaction. If user 501 does not provide a PIN, or alternatively provides an incorrect PIN, merchant system 520 or issuer system 530 may terminate the transaction request.

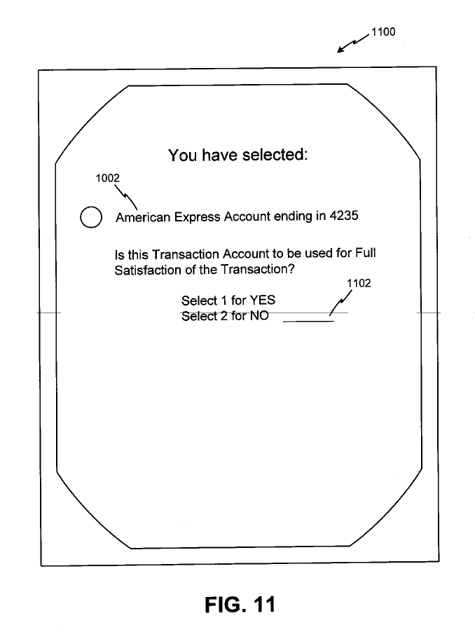

In yet another embodiment of the invention, user 501 may be permitted to select more than one of the transaction account numbers contained on the transaction device database for transaction completion. User 501 may be permitted to allocate portions of the transaction request to multiple transaction account numbers for transaction satisfaction. For example, FIG. 11 depicts a second screen shot 1100 that RFID reader 280 may provide to user 501 subsequent to the selection of a particular transaction account number. For example, user 501 may elect to use a first transaction account number 1002 for full satisfaction of the transaction request. The screen shot 1100 may provide a message 1102 prompting user 501 to identify whether the selected account is to be used for full satisfaction of the transaction request. If so, then merchant system 520 may process the transaction request under business as usual standards using the first transaction account number 1002. Merchant system 520 may provide the first transaction account number 1002 to issuer system 530 for verification and transaction authorization.

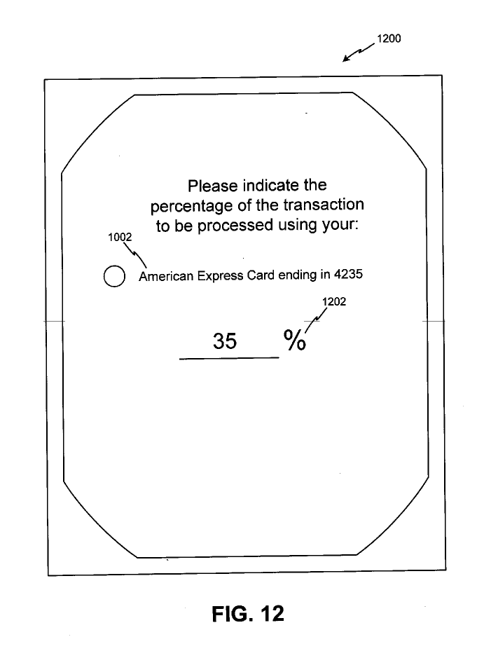

If the user 501 elects to allocate portions of the transaction request to multiple transaction account numbers for transaction satisfaction, reader 280, merchant system 520 or any other system may permit user 501 to identify the portion of the transaction request to allocate to a particular transaction account number. For example, user 501 may desire to allocate 35% of the transaction to a first transaction account number 1002 and 65% to a second transaction account number. In this instance, at screen shot 1100, user 501 may select a first transaction account number, and indicate that the first transaction account number is not to be used for full satisfaction of the transaction request. RFID reader 280 or merchant system 520 may then provide user 501 with a screen shot permitting user 501 to indicate which portion of the transaction request to allocate to the first transaction number. User 501 may indicate which portion to allocate by, for example, providing the key pad with information identifying the allocated portion. In the example illustrated in FIG. 12, user 501 is prompted by message 1202 to provide what percentage of the transaction request is to be allocated to a first transaction account number 1002. As shown, screen shot 1200 indicates that 35% of the transaction is to be allocated to the first transaction account number 1002. Once user 501 indicates the portion, reader 280 or merchant system 520 may return user 501 to a subsequent listing of the available transaction account numbers for use in completing the transaction. The subsequent listing of available transaction account numbers may include all of the transaction account numbers contained on the transaction device database 112, 116, or only those transaction account numbers not yet selected by user 501. Alternatively, the subsequent listing may include notification of which transaction account number user 501 has previously selected.

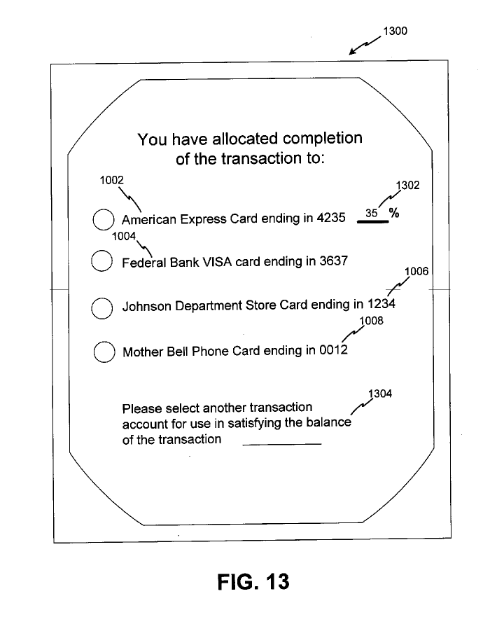

As shown in FIG. 13, an exemplary screen shot 1300 may include the subsequent listing which may additionally include the relevant information pertaining to the allocation made to the first transaction account number 1002 by user 501. For example, screen shot 1300 may include the selected first transaction account number 1002 and the corresponding amount 1302 allocated thereto. User 501 may be permitted to select additional transaction account numbers from the subsequent listing for allocation of portions of the transaction request, or for use in satisfying the balance of the transaction request. For example, user 501 may be provided a message 1304 requiring user 501 to select additional accounts for use in transaction completion. User 501 may be required to select additional transaction account numbers from the subsequent list until the totality of the transaction is satisfied. User 501 may be provided screen shots shown in FIGS. 10-13 and the process repeated until the appropriate portions, or all portions, of the transaction request is fully satisfied.

FIG. 15 depicts an exemplary screen shot 1500 of a display screen that may be presented to user 501 for transaction account selection using a plurality of transaction devices. Screen shot 1500 may include a listing of transaction devices 1502-1508, which may correspond to transaction accounts (e.g., data sets) stored on each transaction device database 112, 116 of each specific transaction device 240. For example, transaction device listing 1502 corresponds to a first transaction device account number (e.g., “American Express Fob with Account ending in 4235”); transaction device listing 1504 corresponds to a second transaction device account number (e.g., “Federal Bank VISA Fob with Account ending in 3637”); transaction device listing 1506 corresponds to a third transaction device account number (e.g., “Johnson Department Store Fob with Account ending in 1234”); and transaction device listing 1508 corresponds to a fourth transaction device account number (e.g., “Mother Bell Phone Fob with Account ending in 0012”).

If user 501 elects to allocate portions of the transaction request to multiple transaction account numbers for transaction satisfaction, RFID reader 280, merchant system 520 or any other system may permit user 501 to identify the portion of the transaction request to allocate to a particular transaction account number. For example, user 501 may desire to allocate 35% of the transaction to a first transaction account number 1502 (on a first transaction device 240) and 65% to a second transaction account number 1504 (on a second transaction device 240). In this instance, at the screen shot 1500, user 501 may select a first transaction device, and indicate that the first transaction device account number is not to be used for full satisfaction of the transaction request. RFID reader 280, merchant system 520 or any other system may then provide user 501 with a screen shot permitting user 501 to indicate which portion of the transaction request to allocate to the first transaction device number. User 501 may indicate which portion to allocate by, for example, providing the key pad with information identifying the allocated portion. User 501 may then be prompted by message similar to message 1102 of FIG. 11 to provide what percentage of the transaction request is to be allocated to a first transaction device account number 1502. Once user 501 indicates the portion, RFID reader 280 or merchant system 520 may return user 501 to a subsequent listing of the available transaction devices for choosing an account number to use in completing the transaction. The subsequent listing of available transaction device account numbers may include all of the transaction device account numbers contained on each transaction device database 112, 116, or only those transaction account numbers not yet selected by user 501. Alternatively, the subsequent listing may include notification of which transaction account number user 501 has previously selected.

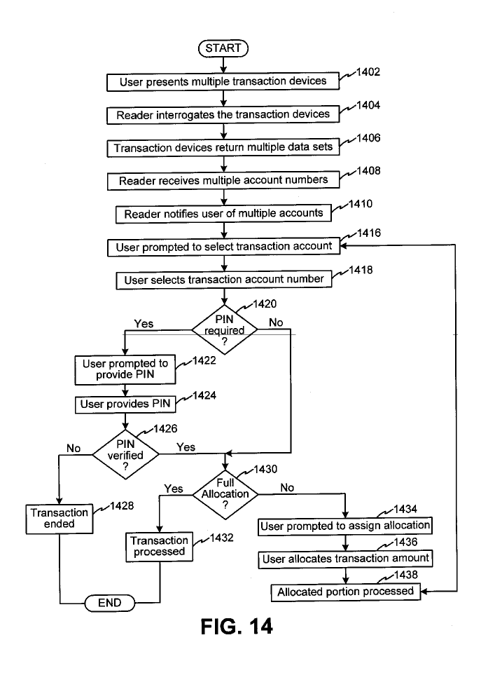

FIG. 14 illustrates an exemplary method for selecting from amongst the multiple transaction account numbers contained on the transaction device databases 112, 116 on multiple transaction devices 240. The method begins with user 501 presenting multiple transaction devices 240 for completion of a transaction (step 1402). In presenting transaction devices 240, user 501 may place the transaction devices within the interrogation zone of a RFID reader 280 (for example, the RFID reader may read the multiple devices when they are located on the same key ring). RFID reader 280 interrogates the transaction devices and then transaction devices 240 and RFID reader 280 may engage in mutual authentication (step 1404). Once transaction devices 240 and RFID reader 280 successfully mutually authenticate, transaction devices 240 provide RFID reader 280 with transaction account information contained in the transaction devices database 112, 116. For detailed description of a suitable interrogation and mutual authentication process for use with the invention, please refer to U.S. Patent Application No. 10/192,488, incorporated by reference above.

Upon successful interrogation and authentication, transaction devices 240 provide RFID reader 280 with the multiple transaction account numbers stored on the transaction device databases 112, 116 (step 1406). In one example, each transaction device's protocol/sequence controller 108 sends a signal to database 112, 116 and the database 112, 116 provides the multiple transaction account numbers to the protocol/sequence controller 108. The protocol sequence controllers 108 of each device may receive the multiple transaction account numbers and provide the multiple transaction account numbers to each modulator/demodulator 106, which in turn provides the multiple transaction account numbers to each transaction device transponder 114. Transponders 114 may provide the multiple transaction account numbers to each transaction device antenna 102, and antennas 102 may provide the multiple transaction account numbers to RFID reader 280, via reader antennas 202 (or optional external antennas 226).

RFID reader 280 may receive the transaction account numbers (step 1408) and provide notice to user 501 that multiple transaction account numbers are present on transaction devices 240 that are available for use in completing a transaction request (step 1410). RFID reader 280 may receive the transaction account numbers at reader transponder 206 via reader antennas 202. Transponders 206 may additionally provide the multiple account numbers to a reader or merchant display screen (not shown) for use in displaying the transaction account numbers to user 501. For example, the reader protocol sequence controller 214 may provide a signal to the reader communications interface 212, which commands the interface 212 to receive the multiple transaction account numbers and provide the multiple transaction account numbers to the display screen.

RFID reader 280 may then prompt user 501 to select at least one of the multiple transaction account numbers for use in transaction completion (step 1416). For example, the reader or merchant display screen may provide user 501 with a screen shot, such as, for example, screen shot 1500 shown in FIG. 15. The screen shot 1500 may include a listing of the multiple transaction account numbers contained on each transaction device database 112, 116, which are available for use in transaction completion. The screen shot 1500 may be configured to permit user 501 to select one of the transaction account numbers, and the screen may provide the transaction account number to RFID reader 280 or merchant system 520 for processing (step 1418).

In some instances, the account issuer 530 that provides the transaction account number to user 501 may require user 501 to provide a PIN or other secondary identifier prior to permitting use of the transaction account number for transaction completion (step 1420). In this case, the display screen may be configured to prompt user 501 to provide the appropriate PIN for verification by RFID reader 280, merchant system 520, or issuer system 530, in any manner discussed above (step 1422). User 501 may provide the PIN (step 1424) and the PIN may be verified under merchant system 520 or issuer system 530 defined verification protocol (step 1426). If the PIN is not verified (step 1426), then merchant system 520 may terminate the transaction request (step 1428).

In some instances, issuer system 530 corresponding to the selected transaction account number may not require a PIN for a particular transaction account number to be used for transaction completion (step 1420), in which case, the transaction account number is processed and the transaction completed under the merchant system's business as usual protocol. For example, merchant system 520 may provide a request for satisfaction of a transaction request to issuer system 530, and issuer system 530 may evaluate the transaction request for transaction completion.

Alternatively, as illustrated in FIG. 11, the display screen may be configured to permit user 501 to select more than one of the multiple transaction account numbers contained on transaction devices 240 for transaction completion. For example, where transaction devices 240 include multiple transaction account numbers, user 501 may allocate portions of the transaction request to the transaction account numbers for satisfaction in accordance with that portion. For example, user 501 may select a first transaction account number from a first transaction device 240 and a second transaction account number from a second transaction device 240 for transaction completion. User 501 may elect to fully allocate the whole of the transaction request to a single transaction account number, or to separate the transaction request amongst multiple transaction account numbers (step 1430). If user 501 elects to allocate the transaction to only one of the transaction account numbers, the transaction request is processed under the merchant system's business as usual standards (step 1432). For example, merchant system 520 receives the transaction account number and provides the transaction account number to the corresponding issuer system 530 by referencing issuer system 530 routing number included in the selected transaction account number. Typical methods of routing a transaction request to an issuer system 530 based on a routing number are well known and will not be discussed herein for brevity.

In another exemplary embodiment, user 501 may elect to allocate only a portion of the transaction request to a selected transaction account number (step 1434). In which case, the display screen may be configured to prompt user 501 to identify the portion of the transaction request to be allocated to the selected transaction account number. For example, display screen 1200, shown in FIG. 12, illustrates a typical prompt for use in identifying which portion of a transaction to allocate to a particular transaction account number. User 501 may identify a portion of the transaction request to be allocated (step 1436) and merchant system 520 may process the allocated portion of the transaction request in accordance with the transaction account number selected and the merchant system business as usual standard, as discussed above (step 1438). That is, the portion of the transaction request to be allocated to the transaction account number is forwarded to issuer system 530 corresponding to the routing number contained in the selected transaction account number.

User 501 may elect to satisfy the balance of the transaction request using one or more of the remaining transaction account numbers contained on one of the multiple transaction account device databases 112, 116, in which case, RFID reader 280 and the merchant system may provide user 501 with a subsequent list of transaction account numbers available for transaction completion and user 501 may select one or more of the transaction account numbers to satisfy the balance of the transaction request, in which case, steps 1416-1438 may be repeated until the transaction is wholly satisfied.

It should be appreciated that the particular implementations shown and described herein are illustrative of the invention and its best mode and are not intended to otherwise limit the scope of the invention in any way. Indeed, for the sake of brevity, conventional data networking, application development and other functional aspects of the systems (and components of the individual operating components of the systems) may not be described in detail herein. It should be noted that many alternative or additional functional relationships or physical connections may be present in a practical data set management system.

As may be appreciated by one of ordinary skill in the art, the invention may be embodied as a method, a data processing system, a device for data processing, and/or a computer program product. Accordingly, the invention may take the form of an entirely software embodiment, an entirely hardware embodiment, or an embodiment combining aspects of both software and hardware. Furthermore, the invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus include steps for implementing the functions specified in the flowchart block or blocks.

It should be noted that although the invention is discussed with respect to Internet Service Providers, and systems and networks which may communicate via a leased line (T1, D3, TCP/IP etc.), the invention is not so limited. The invention contemplates conventional protocol, networks and systems which support a wide range of data transfer. For example, in accordance with this invention, a transaction may be completed using telephone lines connecting long distance carrier systems. In this instance, the issuer-owned data which may be included on transaction devices 240 using any of the methods discussed herein, may be an account number which corresponds to long distance calling time such as may be done with a conventional calling card.

Where transaction devices 240 are loaded with several distinct data sets, each corresponding to a distinct data set owner operating on distinct and non-compatible communications network, the user of transaction devices 240 may use the instrument to complete long distance calls on each of the distinct communications network, independently of the other. This is especially useful for a user who may travel to different locations, where the different locations support different long distance communications network. In this exemplary embodiment, the invention enables a user to anticipate which communications network is available in many different travel destinations, and include the corresponding mating data set on one or more transaction devices 240 prior to beginning travel. In this way, transaction devices 240 user may be prepared to use transaction devices 240 as a long distance calling card irrespective of his anticipated travel destination.

In the foregoing specification, the invention has been described with reference to specific embodiments. However, it may be appreciated that various modifications and changes can be made without departing from the scope of the invention. For example, alternate authentication and verification methods are required by the account issuer system may be employed. The issuer system may require the transaction device to include random number generators, counters, authentication tags, or the like for transaction device, reader, or transaction verification. Additionally, the notifications to the user discussed herein may be visual, audible, or any other suitable notification method capable of conveying to the user that multiple transaction accounts are available for transaction completion. Further, the processing method described herein may be modified so as to permit the selection of a data set from the transaction device using a PIN, where each data set is assigned a PIN, and the user uses the PIN to identify which data set to select for transaction completion. Further still, the user may audibly or physically (e.g., touch screen, input data in touch pad or key pad) select which data set to use. As such, the specification and figures are to be regarded in an illustrative manner applicable irrespective of the data processing protocol used by a data set owner, rather than a restrictive one, and all such modifications are intended to be included within the scope of invention. Accordingly, the scope of the invention should be determined by the appended claims and their legal equivalents, rather than by the examples given above. For example, the steps recited in any of the method or process claims may be executed in any order and are not limited to the order presented. For more information regarding this area of technology, see U.S. Pat. No. 6,845,906, entitled “System and Method for Selecting Financial Services,” issued Jan. 25, 2005 and U.S. Pat. No. 6,685,088, entitled “System and Method for Selecting an Account,” issued Feb. 3, 2004, both of which are incorporated herein by reference in their entirety.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical.”

1.-10. (canceled)

11. A method, comprising:
determining, by a radio frequency identification (RFID) reader, a selection of at least one of a first and second data set based in part on a preference of a first and second data set use and a first and second transaction category of a transaction request,
wherein the first and second data set are associated with the first and second transaction category, respectively, and
wherein the first and second data set include a first and second data set annotation;
receiving, at the RFID reader, a first secondary identification request from a first issuer system prior to authorizing a first portion of the transaction request and a second secondary identification request from a second issuer system prior to authorizing a second portion of the transaction request;
denying access of the first data set to issuer systems other than the first issuer system based on the first data set annotation;
denying access of the second data set to issuer systems other than the second issuer system based on the second data set annotation; and
providing, by the RFID reader, a first biometric sample data associated with a user of the RF transaction device as the first secondary identification to the first issuer system to verify the first secondary identification and authorize the first portion of the transaction request.

12. The method of claim 11, further comprising receiving a user-generated selection of the first portion of the transaction request.

13. The method of claim 11, further comprising transmitting the second secondary identifier to the second issuer system, wherein the second issuer system verifies the second secondary identification and authorizes the transaction request.

14. The method of claim 11, further comprising updating at least one of the first data set or the second data set in response to the transaction request.

15. The method of claim 14, wherein the updating is responsive to received information associated with the RF transaction device.

16. The method of claim 11, wherein at least one of the first data set or the second data set comprises status information.

17. The method of claim 11, further comprising receiving a modification instruction, wherein the modification instruction modifies at least one of the first data set or the second data set.

18.-23. (canceled)

24. The method of claim 11, further comprising:
receiving approval of the transaction request prior to a merchant receiving authorization from a transaction processing entity, in response to a merchant transaction request being in accordance with an approval protocol, wherein the merchant transaction request comprises the transaction request, a merchant identifier, and transaction identifying information.

25. (canceled)

26. The method of claim 11, further comprising transmitting an encrypted authentication tag to the RFID reader.

27. The method of claim 11, further comprising updating a total transactions counter value associated with the RF transaction device.

28.-32. (canceled)

33. The method of claim 18, wherein the data storage area is for storing a third data set.

34. (canceled)

35. (canceled)

36. The method of claim 26, further comprising transmitting the encrypted authentication tag and a routing number to the RFID reader.

37. The method of claim 11, wherein, responsive to first biometric sample data, a first portion of the transaction request is applied to the first data set, and, responsive to second biometric sample data, a second portion of the transaction request is applied to the second data set.

38. (canceled)

39. The method of claim 27, wherein the total transactions counter value is a number corresponding to a number of transactions conducted with the RF transaction device.

40.-43. (canceled)
